(19) United States
(12) Patent Application Publication
(10) Pub. No.: US 2021/0195622 A1
(43) Pub. Date: Jun. 24, 2021

(54) METHOD AND DEVICE FOR RECEIVING UPLINK DATA IN WIRELESS LAN SYSTEM

(71) Applicant: LG ELECTRONICS INC., Seoul (KR)

(72) Inventors: Jinmin KIM, Seoul (KR); Jeongki KIM, Seoul (KR); Kiseon RYU, Seoul (KR); Jinsoo CHOI, Seoul (KR)

(73) Assignee: LG ELECTRONICS INC., Seoul (KR)

(21) Appl. No.: 17/058,579

(22) PCT Filed: Jun. 14, 2019
(86) PCT No.: PCT/KR2019/007217

§ 371 Date: Nov. 24, 2020

(30) Foreign Application Priority Data
Jun. 14, 2018 (KR) 10-2018-0068368
Jul. 6, 2018 (KR) 10-2018-0079004

(51) Int. Cl. H04W 72/12; H04W 72/04

(52) U.S. Cl. CPC H04W 72/1284; H04W 84/12; H04W 72/0453

(57) ABSTRACT

A method and a device for receiving uplink data in a WLAN system are proposed. Specifically, an AP transmits a beacon frame to a first STA or a second STA. The AP receives uplink data from the first STA or the second STA based on the beacon frame. The beacon frame includes information about a transmission mode for the uplink data for each channel in a first band and each channel in a second band. The uplink data is transmitted based on contention when the information about the transmission mode for the uplink data is set to a first value. The uplink data is transmitted based on scheduling when the information about the transmission mode for the uplink data is set to a second value.

### BACKGROUND

### Field

The present disclosure relates to a scheduling transmission mode of an access point (AP) in a wireless local area network (WLAN) system and, more particularly, to a method and a device for receiving uplink data based on a beacon frame or a probe request frame and a probe response frame in a WLAN system.

### Related Art

Discussion for a next-generation wireless local area network (WLAN) is in progress. In the next-generation WLAN, an object is to 1) improve an institute of electronic and electronics engineers (IEEE) 802.11 physical (PHY) layer and a medium access control (MAC) layer in bands of 2.4 GHz and 5 GHz, 2) increase spectrum efficiency and area throughput, 3) improve performance in actual indoor and outdoor environments such as an environment in which an interference source exists, a dense heterogeneous network environment, and an environment in which a high user load exists, and the like.

An environment which is primarily considered in the next-generation WLAN is a dense environment in which access points (APs) and stations (STAs) are a lot and under the dense environment, improvement of the spectrum efficiency and the area throughput is discussed. Further, in the next-generation WLAN, in addition to the indoor environment, in the outdoor environment which is not considerably considered in the existing WLAN, substantial performance improvement is concerned.

In detail, scenarios such as wireless office, smart home, stadium, Hotspot, and building/apartment are largely concerned in the next-generation WLAN and discussion about improvement of system performance in a dense environment in which the APs and the STAs are a lot is performed based on the corresponding scenarios.

In the next-generation WLAN, improvement of system performance in an overlapping basic service set (OBSS) environment and improvement of outdoor environment performance, and cellular offloading are anticipated to be actively discussed rather than improvement of single link performance in one basic service set (BSS). Directionality of the next-generation means that the next-generation WLAN gradually has a technical scope similar to mobile communication. When a situation is considered, in which the mobile communication and the WLAN technology have been discussed in a small cell and a direct-to-direct (D2D) communication area in recent years, technical and business convergence of the next-generation WLAN and the mobile communication is predicted to be further active.

### SUMMARY

The present disclosure proposes a method and a device for receiving uplink data based on a beacon frame in a wireless local area network (WLAN) system.

An embodiment of the present disclosure proposes a method for receiving uplink data based on a beacon frame.

The embodiment may be performed in a network environment supporting a next-generation WLAN system. The next-generation WLAN system may be a WLAN system evolving from an 802.11ax system and may satisfy backward compatibility with the 802.11ax system.

The embodiment may be performed by a transmission device, and the transmission device may correspond to an access point (AP). In the embodiment, a reception device may correspond to a STA (non-AP STA), wherein a first STA may support the 802.11ax WLAN system and a second STA may support an extremely high throughput (EHT) WLAN system.

The AP transmits a beacon frame to the first STA or the second STA.

The AP receives uplink data from the first STA or the second STA based on the beacon frame.

The beacon frame includes information about a transmission mode for the uplink data for each channel in a first band and each channel in a second band. When the information about the transmission mode for the uplink data is set to a first value, the uplink data is transmitted based on contention (that is, EDCA is allowed). When the information about the transmission mode for the uplink data is set to a second value, the uplink data is transmitted based on scheduling (that is, EDCA is not allowed). Here, the information about the transmission mode for the uplink data is one bit, and thus the first value may be 0 and the second value may be 1.

The first band may be a 2.4 GHz or 5 GHz band, and the second band may be a 6 GHz band.

The beacon frame may further include information about a transmission mode for the uplink data for each channel in a third band. Here, the first band may be a 2.4 GHz band, the second band may be a 5 GHz band, and the third band may be a 6 GHz band (a triple band is configured).

The beacon frame may be transmitted in the second band. The first STA and the second STA support the 802.11ax WLAN system and the EHT WLAN system, respectively, and thus may also receive the beacon frame in the second band.

Next, an example of configuring information about a transmission mode for uplink data for each channel in each band is illustrated.

The first band may include a first channel and the second channel. The second band may include a third channel and a fourth channel. The first channel may be a primary channel of the first band, and the second channel may be a secondary channel of the first band. The third channel may be a primary channel of the second band, and the fourth channel may be a secondary channel of the second band. This channelization in which the two bands and the two channels per band are configured is merely an example, and the WLAN system may support various numbers of bands and channels.

When information about a transmission mode for the uplink data for the first channel is set to the first value, the uplink data may be transmitted in the first channel based on contention.

When information about a transmission mode for the uplink data for the second channel is set to the second value, the uplink data may be transmitted in the second channel based on scheduling.

That is, based on the information indicated by the beacon frame, EDCA may be allowed in the first channel in the first band, and EDCA may not be allowed in the second channel.

When information about a transmission mode for the uplink data for the third channel is set to the first value, the uplink data may be transmitted in the third channel based on contention.

When information about a transmission mode for the uplink data for the fourth channel is set to the second value, the uplink data may be transmitted in the fourth channel based on scheduling.

That is, based on the information indicated by the beacon frame, EDCA may be allowed in the third channel in the second band, and EDCA may not be allowed in the fourth channel.

To transmit the uplink data based on scheduling, a trigger frame is needed.

Therefore, the AP may transmit a trigger frame to the first STA and the second STA. The AP may transmit the trigger frame before receiving the uplink data after transmitting the beacon frame.

The uplink data may be transmitted through a resource unit (RU) allocated in the third channel or the fourth channel based on the trigger frame.

Further, when the trigger frame includes an identifier of the first STA and does not include an identifier of the second STA, the uplink data may received only from the first STA. According to the trigger frame, the second STA cannot transmit uplink data.

That is, the trigger frame may determine a STA to transmit uplink data through identifier information and may determine a resource unit for transmitting data in a channel allowed for scheduling-based data transmission through allocation information.

The beacon frame may further include a multi-user (MU) enhanced distributed channel access (EDCA) parameter set element. The MU EDCA parameter set element may be an element defined in the 802.11ax system.

The MU EDCA parameter set element may include a parameter record field for each access category (AC). The parameter record field may include information about a MU EDCA timer. When the information about the MU EDCA timer is set to a third value, the uplink data may be transmitted based on scheduling.

The AC may include AC_Best Effort (BE), AC_Background (BK), AC_Video (VI), and AC_Voice (VO).

The parameter record field may further include an arbitration inter-frame space number (AIFSN) field. When the AIFSN field is set to 0, EDCA for the uplink data may not be performed during a period specified by the MU EDCA timer.

The present disclosure proposes a technique for receiving uplink data based on a beacon frame a WLAN system.

According to an embodiment proposed in the present disclosure, it is possible to prevent a legacy STA from performing uplink transmission in a specific band and to control individual contentions between EHT STAs in the specific band, thus reducing the number of contentions between STAs as compared to an existing technique. Accordingly, efficiency in the specific band may be improved, and system throughput may be guaranteed.

### BRIEF DESCRIPTION OF THE DRAWINGS

FIG. 1 is a conceptual view illustrating the structure of a wireless local area network (WLAN).

FIG. 2 is a diagram illustrating an example of a PPDU used in an IEEE standard.

FIG. 3 is a diagram illustrating an example of an HE PDDU.

FIG. 4 is a diagram illustrating a layout of resource units (RUs) used in a band of 20 MHz.

FIG. 5 is a diagram illustrating a layout of resource units (RUs) used in a band of 40 MHz.

FIG. 6 is a diagram illustrating a layout of resource units (RUs) used in a band of 80 MHz.

FIG. 7 is a diagram illustrating another example of the HE PPDU.

FIG. 8 is a block diagram illustrating one example of HE-SIG-B according to an embodiment.

FIG. 9 illustrates an example of a trigger frame.

FIG. 10 illustrates an example of a common information field.

FIG. 11 illustrates an example of a sub-field being included in a per user information field.

FIG. 12 illustrates an example of an HE TB PPDU.

FIG. 13 illustrates an example of a power saving mechanism.

FIG. 14 illustrates another example of a power saving mechanism.

FIG. 15 illustrates still another example of a power saving mechanism.

FIG. 16 illustrates an active/passive scanning procedure.

FIG. 17 illustrates a scanning/authentication/association procedure.

FIG. 18 is a flowchart illustrating a scanning/authentication/association procedure.

FIG. 19 illustrates the format of a MU EDCA parameter set element according to an embodiment.

FIG. 20 illustrates the format of a MU AC parameter record field according to an embodiment.

FIG. 21 illustrates an example of indicating a UL EDCA method for each multi-band or multi-channel according to an embodiment.

FIG. 22 illustrates a procedure for transmitting uplink data based on a beacon frame according to an embodiment.

FIG. 23 is a flowchart illustrating a procedure for an AP to receive uplink data according to an embodiment.

FIG. 24 is a flowchart illustrating a procedure for a STA to transmit uplink data according to an embodiment.

FIG. 25 is a diagram showing a device for implementing the above-described method.

FIG. 26 shows a more detailed wireless device implementing an embodiment of the present disclosure.

### DESCRIPTION OF EXEMPLARY EMBODIMENTS

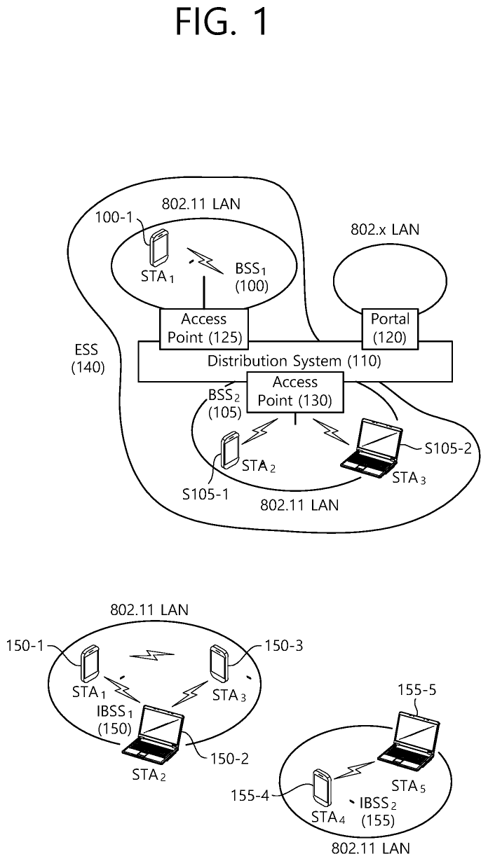

FIG. 1 is a conceptual view illustrating the structure of a wireless local area network (WLAN).

An upper part of FIG. 1 illustrates the structure of an infrastructure basic service set (BSS) of institute of electrical and electronic engineers (IEEE) 802.11.

Referring the upper part of FIG. 1, the wireless LAN system may include one or more infrastructure BSSs 100 and 105 (hereinafter, referred to as BSS). The BSSs 100 and 105 as a set of an AP and a STA such as an access point (AP) 125 and a station (STA 1) 100-1 which are successfully synchronized to communicate with each other are not concepts indicating a specific region. The BSS 105 may include one or more STAs 105-1 and 105-2 which may be joined to one AP 130.

The BSS may include at least one STA, APs providing a distribution service, and a distribution system (DS) 110 connecting multiple APs.

The distribution system 110 may implement an extended service set (ESS) 140 extended by connecting the multiple BSSs 100 and 105. The ESS 140 may be used as a term indicating one network configured by connecting one or more APs 125 or 230 through the distribution system 110. The AP included in one ESS 140 may have the same service set identification (SSID).

A portal 120 may serve as a bridge which connects the wireless LAN network (IEEE 802.11) and another network (e.g., 802.X).

In the BSS illustrated in the upper part of FIG. 1, a network between the APs 125 and 130 and a network between the APs 125 and 130 and the STAs 100-1, 105-1, and 105-2 may be implemented. However, the network is configured even between the STAs without the APs 125 and 130 to perform communication. A network in which the communication is performed by configuring the network even between the STAs without the APs 125 and 130 is defined as an Ad-Hoc network or an independent basic service set (IBSS).

A lower part of FIG. 1 illustrates a conceptual view illustrating the IBSS.

Referring to the lower part of FIG. 1, the IBSS is a BSS that operates in an Ad-Hoc mode. Since the IBSS does not include the access point (AP), a centerized management entity that performs a management function at the center does not exist. That is, in the IBSS, STAs 150-1, 150-2, 150-3, 155-4, and 155-5 are managed by a distributed manner. In the IBSS, all STAs 150-1, 150-2, 150-3, 155-4, and 155-5 may be constituted by movable STAs and are not permitted to access the DS to constitute a self-contained network.

The STA as a predetermined functional medium that includes a medium access control (MAC) that follows a regulation of an Institute of Electrical and Electronics Engineers (IEEE) 802.11 standard and a physical layer interface for a radio medium may be used as a meaning including all of the APs and the non-AP stations (STAs).

The STA may be called various a name such as a mobile terminal, a wireless device, a wireless transmit/receive unit (WTRU), user equipment (UE), a mobile station (MS), a mobile subscriber unit, or just a user.

Meanwhile, the term user may be used in diverse meanings, for example, in wireless LAN communication, this term may be used to signify a STA participating in uplink MU MIMO and/or uplink OFDMA transmission. However, the meaning of this term will not be limited only to this.

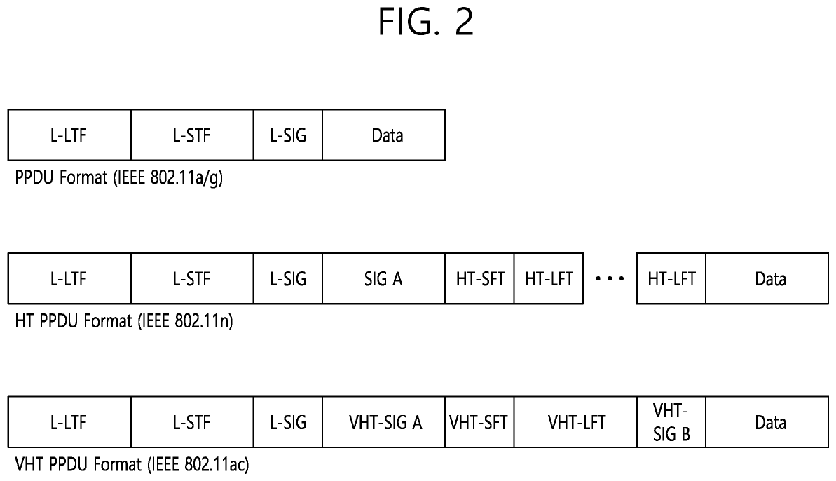

FIG. 2 is a diagram illustrating an example of a PPDU used in an IEEE standard.

As illustrated in FIG. 2, various types of PHY protocol data units (PPDUs) may be used in a standard such as IEEE a/g/n/ac, etc. In detail, LTF and STF fields include a training signal, SIG-A and SIG-B include control information for a receiving station, and a data field includes user data corresponding to a PSDU.

In the embodiment, an improved technique is provided, which is associated with a signal (alternatively, a control information field) used for the data field of the PPDU. The signal provided in the embodiment may be applied onto high efficiency PPDU (HE PPDU) according to an IEEE 802.11ax standard. That is, the signal improved in the embodiment may be HE-SIG-A and/or HE-SIG-B included in the HE PPDU. The HE-SIG-A and the HE-SIG-B may be represented even as the SIG-A and SIG-B, respectively. However, the improved signal proposed in the embodiment is not particularly limited to an HE-SIG-A and/or HE-SIG-B standard and may be applied to control/data fields having various names, which include the control information in a wireless communication system transferring the user data.

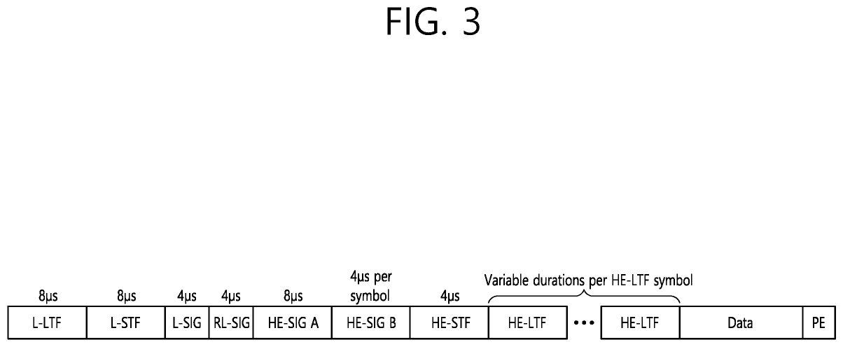

FIG. 3 is a diagram illustrating an example of an HE PDDU.

The control information field provided in the embodiment may be the HE-SIG-B included in the HE PPDU. The HE PPDU according to FIG. 3 is one example of the PPDU for multiple users and only the PPDU for the multiple users may include the HE-SIG-B and the corresponding HE SIG-B may be omitted in a PPDU for a single user.

As illustrated in FIG. 3, the HE-PPDU for multiple users (MUs) may include a legacy-short training field (L-STF), a legacy-long training field (L-LTF), a legacy-signal (L-SIG), a high efficiency-signal A (HE-SIG A), a high efficiency-signal-B (HE-SIG B), a high efficiency-short training field (HE-STF), a high efficiency-long training field (HE-LTF), a data field (alternatively, an MAC payload), and a packet extension (PE) field. The respective fields may be transmitted during an illustrated time period (that is, 4 or 8 μs).

More detailed description of the respective fields of FIG. 3 will be made below.

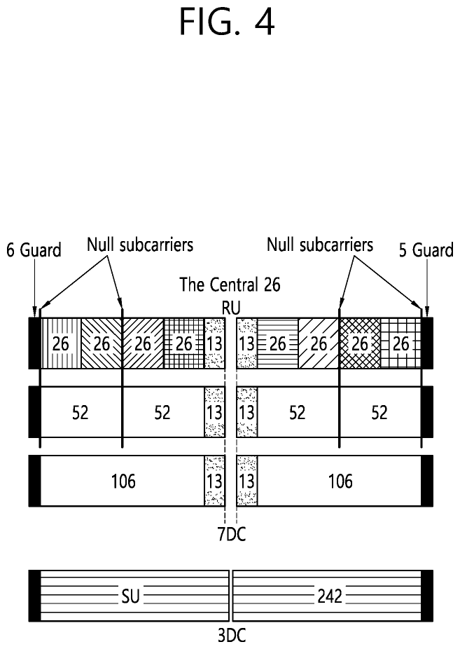

FIG. 4 is a diagram illustrating a layout of resource units (RUs) used in a band of 20 MHz.

As illustrated in FIG. 4, resource units (RUs) corresponding to tone (that is, subcarriers) of different numbers are used to constitute some fields of the HE-PPDU. For example, the resources may be allocated by the unit of the RU illustrated for the HE-STF, the HE-LTF, and the data field.

As illustrated in an uppermost part of FIG. 4, 26 units (that is, units corresponding to 26 tones). 6 tones may be used as a guard band in a leftmost band of the 20 MHz band and 5 tones may be used as the guard band in a rightmost band of the 20 MHz band. Further, 7 DC tones may be inserted into a center band, that is, a DC band and a 26-unit corresponding to each 13 tones may be present at left and right sides of the DC band. The 26-unit, a 52-unit, and a 106-unit may be allocated to other bands. Each unit may be allocated for a receiving station, that is, a user.

Meanwhile, the RU layout of FIG. 4 may be used even in a situation for a single user (SU) in addition to the multiple users (MUs) and in this case, as illustrated in a lowermost part of FIG. 4, one 242-unit may be used and in this case, three DC tones may be inserted.

In one example of FIG. 4, RUs having various sizes, that is, a 26-RU, a 52-RU, a 106-RU, a 242-RU, and the like are proposed, and as a result, since detailed sizes of the RUs may extend or increase, the embodiment is not limited to a detailed size (that is, the number of corresponding tones) of each RU.

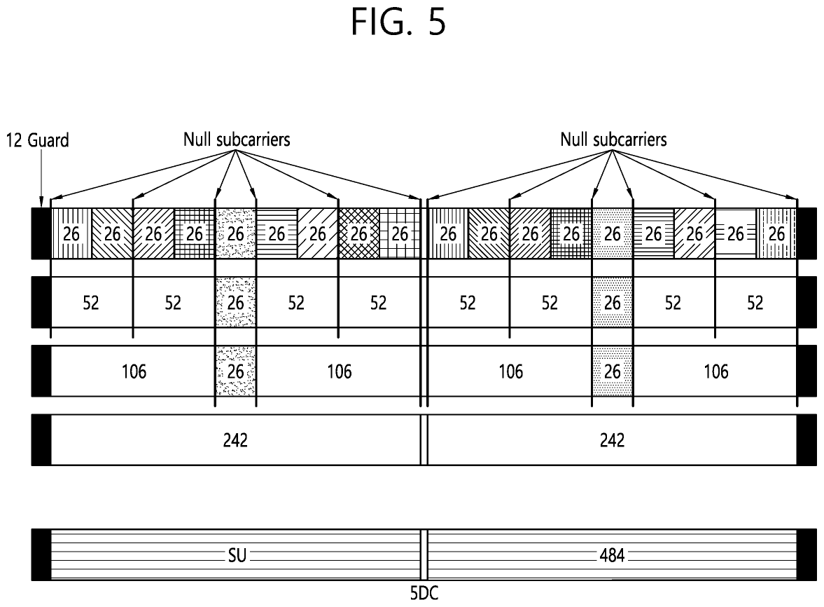

FIG. 5 is a diagram illustrating a layout of resource units (RUs) used in a band of 40 MHz.

Similarly to a case in which the RUs having various RUs are used in one example of FIG. 4, 26-RU, 52-RU, 106-RU, 242-RU, 484-RU, and the like may be used even in one example of FIG. 5. Further, 5 DC tones may be inserted into a center frequency, 12 tones may be used as the guard band in the leftmost band of the 40 MHz band and 11 tones may be used as the guard band in the rightmost band of the 40 MHz band.

In addition, as illustrated in FIG. 5, when the RU layout is used for the single user, the 484-RU may be used. That is, the detailed number of RUs may be modified similarly to one example of FIG. 4.

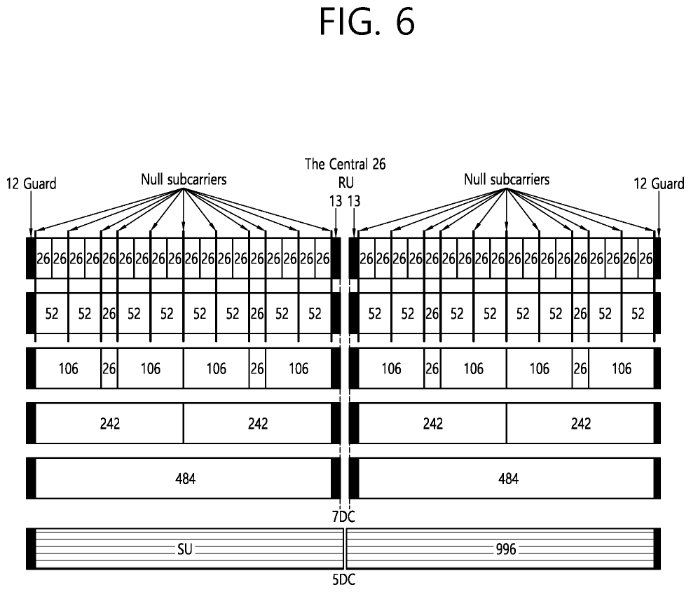

FIG. 6 is a diagram illustrating a layout of resource units (RUs) used in a band of 80 MHz.

Similarly to a case in which the RUs having various RUs are used in one example of each of FIG. 4 or 5, 26-RU, 52-RU, 106-RU, 242-RU, 484-RU, and the like may be used even in one example of FIG. 6. Further, 7 DC tones may be inserted into the center frequency, 12 tones may be used as the guard band in the leftmost band of the 80 MHz band and 11 tones may be used as the guard band in the rightmost band of the 80 MHz band. In addition, the 26-RU may be used, which uses 13 tones positioned at each of left and right sides of the DC band.

Moreover, as illustrated in FIG. 6, when the RU layout is used for the single user, 996-RU may be used and in this case, 5 DC tones may be inserted.

Meanwhile, the detailed number of RUs may be modified similarly to one example of each of FIG. 4 or 5.

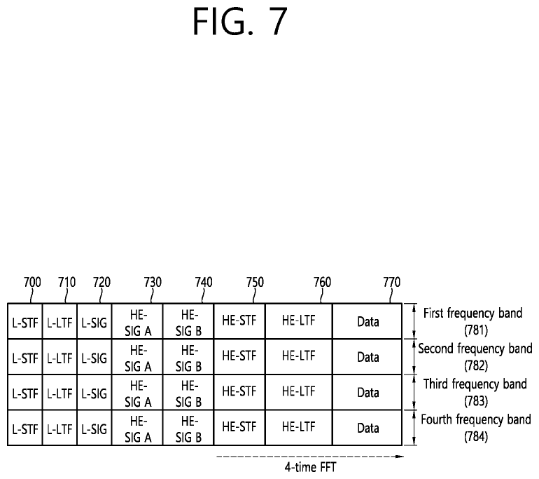

FIG. 7 is a diagram illustrating another example of the HE PPDU.

A block illustrated in FIG. 7 is another example of describing the HE-PPDU block of FIG. 3 in terms of a frequency.

An illustrated L-STF 700 may include a short training orthogonal frequency division multiplexing (OFDM) symbol. The L-STF 700 may be used for frame detection, automatic gain control (AGC), diversity detection, and coarse frequency/time synchronization.

An L-LTF 710 may include a long training orthogonal frequency division multiplexing (OFDM) symbol. The L-LTF 710 may be used for fine frequency/time synchronization and channel prediction.

An L-SIG 720 may be used for transmitting control information. The L-SIG 720 may include information regarding a data rate and a data length. Further, the L-SIG 720 may be repeatedly transmitted. That is, a new format, in which the L-SIG 720 is repeated (for example, may be referred to as R-LSIG) may be configured.

An HE-SIG-A 730 may include the control information common to the receiving station.

In detail, the HE-SIG-A 730 may include information on 1) a DL/UL indicator, 2) a BSS color field indicating an identify of a BSS, 3) a field indicating a remaining time of a current TXOP period, 4) a bandwidth field indicating at least one of 20, 40, 80, 160 and 80+80 MHz, 5) a field indicating an MCS technique applied to the HE-SIG-B, 6) an indication field regarding whether the HE-SIG-B is modulated by a dual subcarrier modulation technique for MCS, 7) a field indicating the number of symbols used for the HE-SIG-B, 8) a field indicating whether the HE-SIG-B is configured for a full bandwidth MIMO transmission, 9) a field indicating the number of symbols of the HE-LTF, 10) a field indicating the length of the HE-LTF and a CP length, 11) a field indicating whether an OFDM symbol is present for LDPC coding, 12) a field indicating control information regarding packet extension (PE), 13) a field indicating information on a CRC field of the HE-SIG-A, and the like. A detailed field of the HE-SIG-A may be added or partially omitted. Further, some fields of the HE-SIG-A may be partially added or omitted in other environments other than a multi-user (MU) environment.

In addition, the HE-SIG-A 730 may be composed of two parts: HE-SIG-A1 and HE-SIG-A2. HE-SIG-A1 and HE-SIG-A2 included in the HE-SIG-A may be defined by the following format structure (fields) according to the PPDU. First, the HE-SIG-A field of the HE SU PPDU may be defined as follows.

TABLE 1

| Two Parts of | | | Number | |
|---|---|---|---|---|
| HE-SIG-A | Bit | Field | of bits | Description |
| HE-SIG-A1 | B0 | Format | 1 | Differentiate an HE SU PPDU and HE ER SU PPDU |
| | | | | from an HE TB PPDU: |
| | | | | Set to 1 for an HE SU PPDU and HE ER SU PPDU |
| | B1 | Beam | 1 | Set to 1 to indicate that the pre-HE modulated fields of |
| | | Change | | the PPDU are spatially mapped differently from the |
| | | | | first symbol of the HE-LTF. Equation (28-6), |
| | | | | Equation (28-9), Equation (28-12), Equation (28-14), |
| | | | | Equation (28-16) and Equation (28-18) apply if the |
| | | | | Beam Change field is set to 1. |
| | | | | Set to 0 to indicate that the pre-HE modulated fields of |
| | | | | the PPDU are spatially mapped the same way as the |
| | | | | first symbol of the HE-LTF on each tone. Equation (28- |
| | | | | 8), Equation (28-10), Equation (28-13), Equation (28- |
| | | | | 15), Equation (28-17) and Equation (28-19) apply if the |
| | | | | Beam Change field is set to 0. (#16803) |
| | B2 | UL/DL | 1 | Indicates whether the PPDU is sent UL or DL. Set to |
| | | | | the value indicated by the TXVECTOR parameter |
| | | | | UPLINK_FLAG. |
| | B3-B6 | MCS | 4 | For an HE SU PPDU: |
| | | | | Set to n for MCSn, where n = 0, 1, 2, . . . , 11 |
| | | | | Values 12-15 are reserved |
| | | | | For HE ER SU PPDU with Bandwidth field set to 0 |
| | | | | (242-tone RU): |
| | | | | Set to n for MCSn, where n = 0, 1, 2 |
| | | | | Values 3-15 are reserved |
| | | | | For HE ER SU PPDU with Bandwidth field set to 1 |
| | | | | (upper frequency 106-tone RU): |
| | | | | Set to 0 for MCS 0 |
| | | | | Values 1-15 are reserved |
| | B7 | DCM | 1 | Indicates whether or not DCM is applied to the Data |
| | | | | field for the MCS indicated. |
| | | | | If the STBC field is 0, then set to 1 to indicate that |
| | | | | DCM is applied to the Data field. Neither DCM nor |
| | | | | STBC shall be applied if(#15489) both the DCM and |
| | | | | STBC are set to 1. |
| | | | | Set to 0 to indicate that DCM is not applied to the |
| | | | | Data field. |
| | | | | NOTE-DCM is applied only to HE-MCSs 0, 1, 3 and |
| | | | | 4. DCM is applied only to 1 and 2 spatial streams. |
| | | | | DCM is not applied in combination with |
| | | | | STBC(#15490). |
| | B8-B13 | BSS Color | 6 | The BSS Color field is an identifier of the BSS. |
| | | | | Set to the value of the TXVECTOR parameter BSS_-COLOR. |
| | B14 | Reserved | 1 | Reserved and set to 1 |
| | B15-B18 | Spatial Reuse | 4 | Indicates whether or not spatial reuse is allowed during |
| | | | | the transmission of this PPDU(#16804). |
| | | | | Set to a value from Table 28-21 (Spatial Reuse field |
| | | | | encoding for an HE SU PPDU, HE ER SU PPDU, and |
| | | | | HE MU PPDU), see 27.11.6 (SPATIAL_REUSE). |
| | | | | Set to SRP_DISALLOW to prohibit SRP-based spatial |
| | | | | reuse during this PPDU. Set to |
| | | | | SRP_AND_NON_SRG_OBSS_PD_PROHIBITED |
| | | | | to prohibit both SRP-based spatial reuse and non-SRG |
| | | | | OBSS PD-based spatial reuse during this PPDU. For |
| | | | | the interpretation of other values see 27.11.6 |
| | | | | (SPATIAL_REUSE) and 27.9 (Spatial reuse operation). |
| | B19-B20 | Bandwidth | 2 | For an HE SU PPDU: |
| | | | | Set to 0 for 20 MHz |
| | | | | Set to 1 for 40 MHz |
| | | | | Set to 2 for 80 MHz |
| | | | | Set to 3 for 160 MHz and 80 + 80 MHz |
| | | | | For an HE ER SU PPDU: |
| | | | | Set to 0 for 242-tone RU |
| | | | | Set to 1 for upper frequency 106-tone RU within the |
| | | | | primary 20 MHz |
| | | | | Values 2 and 3 are reserved |
| | B21-B22 | GI + LTF Size | 2 | Indicates the GI duration and HE-LTF size. |
| | | | | Set to 0 to indicate a 1x HE-LTF and 0.8 μs GI |
| | | | | Set to 1 to indicate a 2x HE-LTF and 0.8 μs GI |
| | | | | Set to 2 to indicate a 2x HE-LTF and 1.6 μs GI |
| | | | | Set to 3 to indicate: |
| | | | | a 4x HE-LTF and 0.8 μs GI if both the DCM |
| | | | | and STBC fields are 1. Neither DCM nor |
| | | | | STBC shall be applied if(#Ed) both the DCM |
| | | | | and STBC fields are set to 1. |
| | | | | a 4x HE-LTF and 3.2 μs GI, otherwise |
| | B23-B25 | NSTS And | 3 | If the Doppler field is 0, indicates the number of space- |
| | | Midamble | | time streams. |
| | | Periodicity | | Set to the number of space-time streams minus 1 |
| | | | | For an HE ER SU PPDU, values 2 to 7 are reserved |
| | | | | If the Doppler field is 1, then B23-B24 indicates the |
| | | | | number of space time streams, up to 4, and B25 |
| | | | | indicates the midamble periodicity. |
| | | | | B23-B24 is set to the number of space time streams |
| | | | | minus 1. |
| | | | | For an HE ER SU PPDU, values 2 and 3 are reserved |
| | | | | B25 is set to 0 if TXVECTOR parameter |
| | | | | MIDAMBLE_PERIODICITY is 10 and set to 1 if TXVECTOR |
| | | | | parameter MIDAMBLE_PERIODICITY is 20. |
| HE-SIG-A2 | B0-B6 | TXOP | 7 | Set to 127 to indicate no duration information |
| (HE SU PPDU) | | | | if(#15491) TXVECTOR parameter TXOP_DURATION |
| or HE-SIG-A3 | | | | is set to UNSPECIFIED. |
| (HE ER SU | | | | Set to a value less than 127 to indicate duration |
| PPDU) | | | | information for NAV setting and protection of the |
| | | | | TXOP as follows: |
| | | | | If TXVECTOR parameter TXOP_DURAT1ON is |
| | | | | less than 512, then B0 is set to 0 and B1-B6 is set to |
| | | | | floor(TXOP_DURATION/8)(#16277). |
| | | | | Otherwise, B0 is set to 1 and B1-B6 is set to floor |
| | | | | ((TXOP_DURATION - 512 )/128)(#16277). |
| | | | | where(#16061) |
| | | | | B0 indicates the TXOP length granularity. Set to 0 |
| | | | | for 8 μs; otherwise set to 1 for 128 μs. |
| | | | | B1-B6 indicates the scaled value of the TXOP_DURATION |
| | B7 | Coding | 1 | Indicates whether BCC or LDPC is used: |
| | | | | Set to 0 to indicate BCC |
| | | | | Set to 1 to indicate LDPC |
| | B8 | LDPC Extra | 1 | Indicates the presence of the extra OFDM symbol |
| | | Symbol | | segment for LDPC: |
| | | Segment | | Set to 1 if an extra OFDM symbol segment for |
| | | | | LDPC is present |
| | | | | Set to 0 if an extra OFDM symbol segment for |
| | | | | LDPC is not present |
| | | | | Reserved and set to 1 if the Coding field is set to |
| | | | | 0(#15492). |
| | B9 | STBC | 1 | If the DCM field is set to 0, then set to 1 if space time |
| | | | | block coding is used. Neither DCM nor STBC shall be |
| | | | | applied if(#15493) both the DCM field and STBC field |
| | | | | are set to 1. |
| | | | | Set to 0 otherwise. |
| | B10 | Beam- | 1 | Set to 1 if a beamforming steering matrix is applied to |
| | | formed(#16038) | | the waveform in an SU transmission. |
| | | | | Set to 0 otherwise. |
| | B11-B12 | Pre-FEC | 2 | Indicates the pre-FEC padding factor. |
| | | Padding | | Set to 0 to indicate a pre-FEC padding factor of 4 |
| | | Factor | | Set to 1 to indicate a pre-FEC padding factor of 1 |
| | | | | Set to 2 to indicate a pre-FEC padding factor of 2 |
| | | | | Set to 3 to indicate a pre-FEC padding factor of 3 |
| | B13 | PE Disambiguity | 1 | Indicates PE disambiguity(#16274) as defined in |
| | | | | 28.3.12 (Packet extension). |
| | B14 | Reserved | 1 | Reserved and set to 1 |
| | B15 | Doppler | 1 | Set to 1 if one of the following applies: |
| | | | | The number of OFDM symbols in the Data |
| | | | | field is larger than the signaled midamble periodicity |
| | | | | plus 1 and the midamble is present |
| | | | | The number of OFDM symbols in the Data |
| | | | | field is less than or equal to the signaled midamble |
| | | | | periodicity plus 1 (see 28.3.11.16 Midamble), |
| | | | | the midamble is not present, but the |
| | | | | channel is fast varying. It recommends that |
| | | | | midamble may be used for the PPDUs of the |
| | | | | reverse link. |
| | | | | Set to 0 otherwise. |
| | B16-B19 | CRC | 4 | CRC for bits 0-41 of the HE-SIG-A field (see |
| | | | | 28.3.10.7.3 (CRC computation)). Bits 0-41 of the |
| | | | | HE-SIG-A field correspond to bits 0-25 of HE-SIG-A1 |
| | | | | followed by bits 0-15 of HE-SIG-A2). |
| | B20-B25 | Tail | 6 | Used to terminate the trellis of the convolutional |
| | | | | decoder. |
| | | | | Set to 0. |

In addition, the HE-SIG-A field of the HE MU PPDU may be defined as follows.

TABLE 2

| Two Parts of | | | Number | |
|---|---|---|---|---|
| HE-SIG-A | Bit | Field | of bits | Description |
| HE-SIG-A1 | B0 | UL/DL | 1 | Indicates whether the PPDU is sent UL or DL. Set to |
| | | | | the value indicated by the TXVECTOR parameter |
| | | | | UPLINK_FLAG. (#16805) |
| | | | | NOTE-The TDLS peer can identify the TDLS frame |
| | | | | by To DS and From DS fields in the MAC header of the |
| | | | | MPDU. |
| | B1-B3 | SIGB MCS | 3 | Indicates the MCS of the HE-SIG-B field: |
| | | | | Set to 0 for MCS 0 |
| | | | | Set to 1 for MCS 1 |
| | | | | Set to 2 for MCS 2 |
| | | | | Set to 3 for MCS 3 |
| | | | | Set to 4 for MCS 4 |
| | | | | Set to 5 for MCS 5 |
| | | | | The values 6 and 7 are reserved |
| | B4 | SIGB DCM | 1 | Set to 1 indicates that the HE-SIG-B is modulated with |
| | | | | DCM for the MCS. |
| | | | | Set to 0 indicates that the HE-SIG-B is not modulated |
| | | | | with DCM for the MCS. |
| | | | | NOTE-DCM is only applicable to MCS 0, MCS 1, |
| | | | | MCS 3, and MCS 4. |
| | B5-B10 | BSS Color | 6 | The BSS Color field is an identifier of the BSS. |
| | | | | Set to the value of the TXVECTOR parameter BSS_COLOR. |
| | B11-B14 | Spatial Reuse | 4 | Indicates whether or not spatial reuse is allowed during |
| | | | | the transmission of this PPDU(#16806). |
| | | | | Set to the value of the SPATIAL_REUSE parameter of |
| | | | | the TXVECTOR, which contains a value from |
| | | | | Table 28-21 (Spatial Reuse field encoding for an |
| | | | | HE SU PPDU, HE ER SU PPDU, and HE MU PPDU) (see |
| | | | | 27.11.6 (SPATIAL_REUSE)). |
| | | | | Set to SRP_DISALLOW to prohibit SRP-based spatial |
| | | | | reuse during this PPDU. Set to |
| | | | | SRP_AND_NON_SRG_OBSS_PD_PROHIBITED |
| | | | | to prohibit both SRP-based spatial reuse and non-SRG |
| | | | | OBSS PD-based spatial reuse during this PPDU. For |
| | | | | the interpretation of other values see 27.11.6 |
| | | | | (SPATIAL_REUSE) and 27.9 (Spatial reuse operation). |
| | B15-B17 | Bandwidth | 3 | Set to 0 for 20 MHz. |
| | | | | Set to 1 for 40 MHz. |
| | | | | Set to 2 for 80 MHz non-preamble puncturing mode. |
| | | | | Set to 3 for 160 MHz and 80 + 80 MHz non-preamble |
| | | | | puncturing mode. |
| | | | | If the SIGB Compression field is 0: |
| | | | | Set to 4 for preamble puncturing in 80 MHz, where |
| | | | | in the preamble only the secondary 20 MHz is |
| | | | | punctured. |
| | | | | Set to 5 for preamble puncturing in 80 MHz, where |
| | | | | in the preamble only one of the two 20 MHz sub- |
| | | | | channels in secondary 40 MHz is punctured. |
| | | | | Set to 6 for preamble puncturing in 160 MHz or |
| | | | | 80 + 80 MHz, where in the primary 80 MHz of the |
| | | | | preamble only the secondary 20 MHz is punctured. |
| | | | | Set to 7 for preamble puncturing in 160 MHz or |
| | | | | 80 + 80 MHz, where in the primary 80 MHz of the |
| | | | | preamble the primary 40 MHz is present. |
| | | | | If the SIGB Compression field is 1 then values 4-7 are |
| | | | | reserved. |
| | B18-B21 | Number Of | 4 | If the HE-SIG-B Compression field is set to 0, indicates |
| | | HE-SIG-B | | the number of OFDM symbols in the HE-SIG-B |
| | | Symbols Or | | field: (#15494) |
| | | MU-MIMO | | Set to the number of OFDM symbols in the HE-SIG-B |
| | | Users | | field minus 1 if the number of OFDM symbols in |
| | | | | the HE-SIG-B field is less than 16; |
| | | | | Set to 15 to indicate that the number of OFDM |
| | | | | symbols in the HE-SIG-B field is equal to 16 if Longer |
| | | | | Than 16 HE SIG-B OFDM Symbols Support sub- |
| | | | | field of the HE Capabilities element transmitted by |
| | | | | at least one recipient STA is 0; |
| | | | | Set to 15 to indicate that the number of OFDM |
| | | | | symbols in the HE-SIG-B field is greater than or equal to |
| | | | | 16 if the Longer Than 16 HE SIG-B OFDM Symbols |
| | | | | Support subfield of the HE Capabilities element |
| | | | | transmitted by all the recipient STAs are 1 and if the |
| | | | | HE-SIG-B data rate is less than MCS 4 without |
| | | | | DCM. The exact number of OFDM symbols in the |
| | | | | HE-SIG-B field is calculated based on the number of |
| | | | | User fields in the HE-SIG-B content channel which |
| | | | | is indicated by HE-SIG-B common field in this case. |
| | | | | If the HE-SIG-B Compression field is set to 1, indicates |
| | | | | the number of MU-MIMO users and is set to the number |
| | | | | of NU-MIMO users minus 1(#15495). |
| | B22 | SIGB | 1 | Set to 0 if the Common field in HE-SIG-B is present. |
| | | Compression | | Set to 1 if the Common field in HE-SIG-B is not present. |
| | | | | (#16139) |
| | B23-B24 | GI + LTF Size | 2 | Indicates the GI duration and HE-LTF size: |
| | | | | Set to 0 to indicate a 4x HE-LTF and 0.8 μs GI |
| | | | | Set to 1 to indicate a 2x HE-LTF and 0.8 μs GI |
| | | | | Set to 2 to indicate a 2x HE-LTF and 1.6 μs GI |
| | | | | Set to 3 to indicate a 4x HE-LTF and 3.2 μs GI |
| | B25 | Doppler | 1 | Set to 1 if one of the following applies: |
| | | | | The number of OFDM symbols in the Data |
| | | | | field is larger than the signaled midamble periodicity |
| | | | | plus 1 and the midamble is present |
| | | | | The number of OFDM symbols in the Data |
| | | | | field is less than or equal to the signaled |
| | | | | midamble periodicity plus 1 (see 28.3.11.16 |
| | | | | Midamble), the midamble is not present, but the |
| | | | | channel is fast varying. It recommends that |
| | | | | midamble may be used for the PPDUs of the |
| | | | | reverse link. |
| | | | | Set to 0 otherwise. |
| HE-SIG-A2 | B0-B6 | TXOP | 7 | Set to 127 to indicate no duration information |
| | | | | if(#15496) TXVECTOR parameter TXOP_DURATION |
| | | | | is set to UNSPECIFIED. |
| | | | | Set to a value less than 127 to indicate duration |
| | | | | information for NAV setting and protection of the |
| | | | | TXOP as follows: |
| | | | | If TXVECTOR parameter TXOP_DURATION is |
| | | | | less than 512, then B0 is set to 0 and B1-B6 is set to |
| | | | | floor(TXOP_DURATION/8)(#16277). |
| | | | | Otherwise, B0 is set to 1 and B1-B6 is set to floor |
| | | | | ((TXOP_DURATION - 512)/128)(#16277). |
| | | | | where(#16061) |
| | | | | B0 indicates the TXOP length granularity. Set to 0 |
| | | | | for 8 μs; otherwise set to 1 for 128 μs. |
| | | | | B1-B6 indicates the scaled value of the TXOP_DURATION |
| | B7 | Reserved | 1 | Reserved and set to 1 |
| | B8-B10 | Number of | 3 | If the Doppler field is set to 0(#15497), indicates the |
| | | HE-LTF | | number of HE-LTF symbols: |
| | | Symbols And | | Set to 0 for 1 HE-LTF symbol |
| | | Midamble | | Set to 1 for 2 HE-LTF symbols |
| | | Periodicity | | Set to 2 for 4 HE-LTF symbols |
| | | | | Set to 3 for 6 HE-LTF symbols |
| | | | | Set to 4 for 8 HE-LTF symbols |
| | | | | Other values are reserved. |
| | | | | If the Doppler field is set to 1(#15498), B8-B9 |
| | | | | indicates the number of HE-LTF symbols(#16056) and |
| | | | | B10 indicates midamble periodicity: |
| | | | | B8-B9 is encoded as follows: |
| | | | | 0 indicates 1 HE-LTF symbol |
| | | | | 1 indicates 2 HE-LTF symbols |
| | | | | 2 indicates 4 HE-LTF symbols |
| | | | | 3 is reserved |
| | | | | B10 is set to 0 if the TXVECTOR parameter |
| | | | | MIDAMBLE_PERIODICITY is 10 and set to 1 if the |
| | | | | TXVECTOR parameter PREAMBLE_PERIODICITY is 20. |
| | B11 | LDPC Extra | 1 | Indication of the presence of the extra OFDM symbol |
| | | Symbol | | segment for LDPC. |
| | | Segment | | Set to 1 if an extra OFDM symbol segment for |
| | | | | LDPC is present. |
| | | | | Set to 0 otherwise. |
| | B12 | STBC | 1 | In an HE MU PPDU where each RU includes no more |
| | | | | than 1 user, set to 1 to indicate all RUs are STBC |
| | | | | encoded in the payload, set to 0 to indicate all RUs are |
| | | | | not STBC encoded in the payload. |
| | | | | STBC does not apply to HE-SIG-B. |
| | | | | STBC is not applied if one or more RUs are used for |
| | | | | MU-MIMO allocation. (#15661) |
| | B13-B14 | Pre-FEC | 2 | Indicates the pre-FEC padding factor. |
| | | Padding | | Set to 0 to indicate a pre-FEC padding factor of 4 |
| | | Factor | | Set to 1 to indicate a pre-FEC padding factor of 1 |
| | | | | Set to 2 to indicate a pre-FEC padding factor of 2 |
| | | | | Set to 3 to indicate a pre-FEC padding factor of 3 |
| | B15 | PE Disambiguity | 1 | Indicates PE disambiguity(#16274) as defined in |
| | | | | 28.3.12 (Packet extension). |
| | B16-B19 | CRC | 4 | CRC for bits 0-41 of the HE-SIG-A field (see |
| | | | | 28.3.10.7.3 (CRC computation)). Bits 0-41 of the |
| | | | | HE-SIG-A field correspond to bits 0-25 of HE-SIG-A1 |
| | | | | followed by bits 0-15 of HE-SIG-A2). |
| | B20-B25 | Tail | 6 | Used to terminate the trellis of the convolutional |
| | | | | decoder. |
| | | | | Set to 0. |

In addition, the HE-SIG-A field of the HE TB PPDU may be defined as follows.

TABLE 3

| Two Parts of | | | Number | |
|---|---|---|---|---|
| HE-SIG-A | Bit | Field | of bits | Description |
| HE-SIG-A1 | B0 | Format | 1 | Differentiate an HE SU PPDU and HE ER SU PPDU |
| | | | | from an HE TB PPDU: |
| | | | | Set to 0 for an HE TB PPDU |
| | B1-B6 | BSS Color | 6 | The BSS Color field is an identifier of the BSS. |
| | | | | Set to the value of the TXVECTOR parameter BSS_COLOR. |
| | B7-B10 | Spatial Reuse 1 | 4 | Indicates whether or not spatial reuse is allowed in a |
| | | | | subband of the PPDU during the transmission of this |
| | | | | PPDU, and if allowed, indicates a value that is used to |
| | | | | determine a limit on the transmit power of a spatial |
| | | | | reuse transmission. |
| | | | | If the Bandwidth field indicates 20 MHz, 40 MHz, or |
| | | | | 80 MHz then this Spatial Reuse field applies to the first |
| | | | | 20 MHz subband. |
| | | | | If the Bandwidth field indicates 160/80 + 80 MHz then |
| | | | | this Spatial Reuse field applies to the first 40 MHz sub- |
| | | | | band of the 160 MHz operating band. |
| | | | | Set to the value of the SPATIAL_REUSE(1) parameter |
| | | | | of the TXVECTOR, which contains a value from |
| | | | | Table 28-22 (Spatial Reuse field encoding for an HE |
| | | | | TB PPDU) for an HE TB PPDU (see 27.11.6 (SPATIAL_REUSE)). |
| | | | | Set to SRP_DISALLOW to prohibit SRP-based spatial |
| | | | | reuse during this PPDU. Set to |
| | | | | SRP_AND_NON_SRG_OBSS_PD_PROHIBITED |
| | | | | to prohibit both SRP-based spatial reuse and non-SRG |
| | | | | OBSS PD-based spatial reuse during this PPDU. For |
| | | | | the interpretation of other values see 27.11.6 |
| | | | | (SPATIAL_REUSE) and 27.9 (Spatial reuse operation). |
| | B11-B14 | Spatial Reuse 2 | 4 | Indicates whether or not spatial reuse is allowed in a |
| | | | | subband of the PPDU during the transmission of this |
| | | | | PPDU, and if allowed, indicates a value that is used to |
| | | | | determine a limit on the transmit power of a spatial |
| | | | | reuse transmission. |
| | | | | If the Bandwidth field indicates 20 MHz, 40 MHz, or |
| | | | | 80 MHz: |
| | | | | This Spatial Reuse field applies to the second |
| | | | | 20 MHz subband. |
| | | | | If(#Ed) the STA operating channel width is 20 MHz, |
| | | | | then this field is set to the same value as Spatial |
| | | | | Reuse 1 field. |
| | | | | If(#Ed) the STA operating channel width is 40 MHz |
| | | | | in the 2.4 GHz band, this field is set to the same |
| | | | | value as Spatial Reuse 1 field. |
| | | | | If the Bandwidth field indicates 160/80 + 80 MHz the |
| | | | | this Spatial Reuse field applies to the second 40 MHz |
| | | | | subband of the 160 MHz operating band. |
| | | | | Set to the value of the SPATIAL_REUSE(2) parameter |
| | | | | of the TXVECTOR. which contains a value from |
| | | | | Table 28-22 (Spatial Reuse field encoding for an HE |
| | | | | TB PPDU) for an HE TB PPDU (see 27.11.6 (SPATIAL_REUSE)). |
| | | | | Set to SRP_DISALLOW to prohibit SRP-based spatial |
| | | | | reuse during this PPDU. Set to |
| | | | | SRP_AND_NON_SRG_OBSS_PD_PROIHBITED |
| | | | | to prohibit both SRP-based spatial reuse and non-SRG |
| | | | | OBSS PD-based spatial reuse during this PPDU. For |
| | | | | the interpretation of other values see 27.11.6 |
| | | | | (SPATIAL_REUSE) and 27.9 (Spatial reuse operation). |
| | B15-B18 | Spatial Reuse 3 | 4 | Indicates whether or not spatial reuse is allowed in a |
| | | | | subband of the PPDU during the transmission of this |
| | | | | PPDU, and if allowed, indicates a value that is used to |
| | | | | determine a limit on the transmit power of a spatial |
| | | | | reuse transmission. |
| | | | | If the Bandwidth field indicates 20 MHz, 40 MHz or |
| | | | | 80 MHz: |
| | | | | This Spatial Reuse field applies to the third 20 MHz |
| | | | | subband. |
| | | | | If(#Ed) the STA operating channel width is 20 MHz |
| | | | | or 40 MHz, this field is set to the same value as |
| | | | | Spatial Reuse 1 field. |
| | | | | If the Bandwidth field indicates 160/80 + 80 MHz: |
| | | | | This Spatial Reuse field applies to the third 40 MHz |
| | | | | subband of the 160 MHz operating band. |
| | | | | If(#Ed) the STA operating channel width is |
| | | | | 80 + 80 MHz, this field is set to the same value as |
| | | | | Spatial Reuse 1 field. |
| | | | | Set to the value of the SPATIAL_REUSE(3) parameter |
| | | | | of the TXVECTOR, which contains a value from |
| | | | | Table 28-22 (Spatial Reuse field encoding for an HE |
| | | | | TB PPDU) for an HE TB PPDU (see 27.11.6 (SPATIAL_REUSE)). |
| | | | | Set to SRP_DISALLOW to prohibit SRP-based spatial |
| | | | | reuse during this PPDU. Set to |
| | | | | SRP_AND_NON_SRG_OBSS_PD_PROHIBITED |
| | | | | to prohibit both SRP-based spatial reuse and non-SRG |
| | | | | OBSS PD-based spatial reuse during this PPDU. For |
| | | | | the interpretation of other values see 27.11.6 |
| | | | | (SPATIAL_REUSE) and 27.9 (Spatial reuse operation). |
| | B19-B22 | Spatial Reuse 4 | 4 | Indicates whether or not spatial reuse is allowed in a |
| | | | | subband of the PPDU during the transmission of this |
| | | | | PPDU, and if allowed, indicates a value that is used to |
| | | | | determine a limit on the transmit power of a spatial |
| | | | | reuse transmission. |
| | | | | If the Bandwidth field indicates 20 MHz, 40 MHz or |
| | | | | 80 MHz: |
| | | | | This Spatial Reuse field applies to the fourth |
| | | | | 20 MHz subband. |
| | | | | If(#Ed) the STA operating channel width is 20 MHz, |
| | | | | then this field is set to the same value as Spatial |
| | | | | Reuse 1 field. |
| | | | | If(#Ed) the STA operating channel width is 40 MHz, |
| | | | | then this field is set to the same value as Spatial |
| | | | | Reuse 2 field. |
| | | | | If the Bandwidth field indicates 160/80 + 80 MHz: |
| | | | | This Spatial Reuse field applies to the fourth |
| | | | | 40 MHz subband of the 160 MHz operating band. |
| | | | | If(#Ed) the STA operating channel width is |
| | | | | 80 + 80 MHz, then this field is set to same value as |
| | | | | Spatial Reuse 2 field. |
| | | | | Set to the value of the SPATIAL_REUSE(4) parameter |
| | | | | of the TXVECTOR, which contains a value from |
| | | | | Table 28-22 (Spatial Reuse field encoding for an HE |
| | | | | TB PPDU) for an HE TB PPDU (see 27.11.6 (SPATIAL_REUSE)). |
| | | | | Set to SRP_DISALLOW to prohibit SRP-based spatial |
| | | | | reuse during this PPDU. Set to |
| | | | | SRP_AND_NON_SRG_OBSS_PD_PROHIBITED |
| | | | | to prohibit both SRP-based spatial reuse and non-SRG |
| | | | | OBSS PD-based spatial reuse during this PPDU. For |
| | | | | the interpretation of other values see 27.11.6 |
| | | | | (SPATIAL_REUSE) and 27.9 (Spatial reuse operation). |
| | B23 | Reserved | 1 | Reserved and set to 1. |
| | | | | NOTE-Unlike other Reserved fields in HE-SIG-A of |
| | | | | the HE TB PPDU, B23 does not have a corresponding |
| | | | | bit in the Trigger frame. |
| | B24-B25 | Bandwidth | 2 | (#16003)Set to 0 for 20 MHz |
| | | | | Set to 1 for 40 MHz |
| | | | | Set to 2 for 80 MHz |
| | | | | Set to 3 for 160 MHz and 80 + 80 MHz |
| HE-SIG-A2 | B0-B6 | TXOP | 7 | Set to 127 to indicate no duration information |
| | | | | if(#15499) TXVECTOR parameter TXOP_DURATION |
| | | | | is set to UNSPECIFIED. |
| | | | | Set to a value less than 127 to indicate duration information |
| | | | | for NAV setting and protection of the TXOP as |
| | | | | follows: |
| | | | | If TXVECTOR parameter TXOP_DURATION is |
| | | | | less than 512, then B0 is set to 0 and B1-B6 is set to |
| | | | | floor(TXOP_DURATION/8)(#16277). |
| | | | | Otherwise, B0 is set to 1 and B1-B6 is set to floor |
| | | | | ((TXOP_DURATION - 512)/128)(#16277). |
| | | | | where(#16061) |
| | | | | B0 indicates the TXOP length granularity. Set to 0 |
| | | | | for 8 μs; otherwise set to 1 for 128 μs. |
| | | | | B1-B6 indicates the scaled value of the TXOP_DURATION |
| | B7-B15 | Reserved | 9 | Reserved and set to value indicated in the UL HE-SIG-A2 |
| | | | | Reserved subfield in the Trigger frame. |
| | B16-B19 | CRC | 4 | CRC of bits 0-41 of the HE-SIG-A field. See |
| | | | | 28.3.10.7.3 (CRC computation). Bits 0-41 of the |
| | | | | HE-SIG-A field correspond to bits 0-25 of HE-SIG-A1 |
| | | | | followed by bits 0-15 of HE-SIG-A2). |
| | B20-B25 | Tail | 6 | Used to terminate the trellis of the convolutional |
| | | | | decoder. |
| | | | | Set to 0. |

An HE-SIG-B 740 may be included only in the case of the PPDU for the multiple users (MUs) as described above. Principally, an HE-SIG-A 750 or an HE-SIG-B 760 may include resource allocation information (alternatively, virtual resource allocation information) for at least one receiving STA.

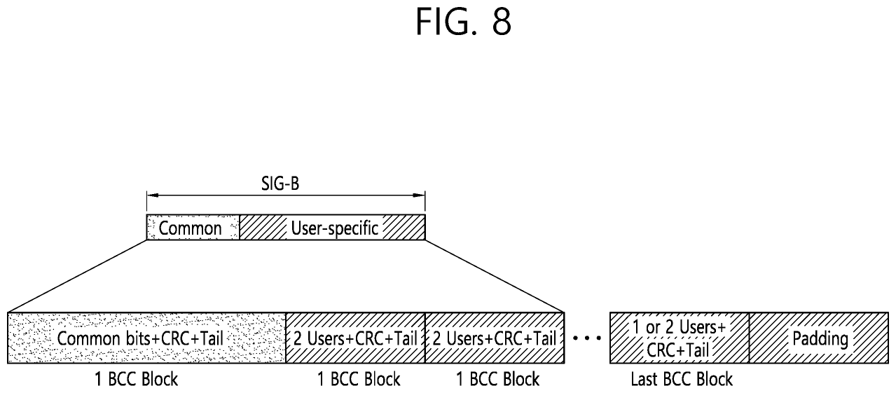

FIG. 8 is a block diagram illustrating one example of HE-SIG-B according to an embodiment.

As illustrated in FIG. 8, the HE-SIG-B field includes a common field at a frontmost part and the corresponding common field is separated from a field which follows therebehind to be encoded. That is, as illustrated in FIG. 8, the HE-SIG-B field may include a common field including the common control information and a user-specific field including user-specific control information. In this case, the common field may include a CRC field corresponding to the common field, and the like and may be coded to be one BCC block. The user-specific field subsequent thereafter may be coded to be one BCC block including the “user-specific field” for 2 users and a CRC field corresponding thereto as illustrated in FIG. 8.

A previous field of the HE-SIG-B 740 may be transmitted in a duplicated form on a MU PPDU. In the case of the HE-SIG-B 740, the HE-SIG-B 740 transmitted in some frequency band (e.g., a fourth frequency band) may even include control information for a data field corresponding to a corresponding frequency band (that is, the fourth frequency band) and a data field of another frequency band (e.g., a second frequency band) other than the corresponding frequency band. Further, a format may be provided, in which the HE-SIG-B 740 in a specific frequency band (e.g., the second frequency band) is duplicated with the HE-SIG-B 740 of another frequency band (e.g., the fourth frequency band). Alternatively, the HE-SIG B 740 may be transmitted in an encoded form on all transmission resources. A field after the HE-SIG B 740 may include individual information for respective receiving STAs receiving the PPDU.

The HE-STF 750 may be used for improving automatic gain control estimation in a multiple input multiple output (MIMO) environment or an OFDMA environment.

The HE-LTF 760 may be used for estimating a channel in the MIMO environment or the OFDMA environment.

The size of fast Fourier transform (FFT)/inverse fast Fourier transform (IFFT) applied to the HE-STF 750 and the field after the HE-STF 750, and the size of the FFT/IFFT applied to the field before the HE-STF 750 may be different from each other. For example, the size of the FFT/IFFT applied to the HE-STF 750 and the field after the HE-STF 750 may be four times larger than the size of the FFT/IFFT applied to the field before the HE-STF 750.

For example, when at least one field of the L-STF 700, the L-LTF 710, the L-SIG 720, the HE-SIG-A 730, and the HE-SIG-B 740 on the PPDU of FIG. 7 is referred to as a first field, at least one of the data field 770, the HE-STF 750, and the HE-LTF 760 may be referred to as a second field. The first field may include a field associated with a legacy system and the second field may include a field associated with an HE system. In this case, the fast Fourier transform (FFT) size and the inverse fast Fourier transform (IFFT) size may be defined as a size which is N (N is a natural number, e.g., N=1, 2, and 4) times larger than the FFT/IFFT size used in the legacy wireless LAN system. That is, the FFT/IFFT having the size may be applied, which is N (=4) times larger than the first field of the HE PPDU. For example, 256 FFT/IFFT may be applied to a bandwidth of 20 MHz, 512 FFT/IFFT may be applied to a bandwidth of 40 MHz, 1024 FFT/IFFT may be applied to a bandwidth of 80 MHz, and 2048 FFT/IFFT may be applied to a bandwidth of continuous 160 MHz or discontinuous 160 MHz.

In other words, a subcarrier space/subcarrier spacing may have a size which is 1/N times (N is the natural number, e.g., N=4, the subcarrier spacing is set to 78.125 kHz) the subcarrier space used in the legacy wireless LAN system. That is, subcarrier spacing having a size of 312.5 kHz, which is legacy subcarrier spacing may be applied to the first field of the HE PPDU and a subcarrier space having a size of 78.125 kHz may be applied to the second field of the HE PPDU.

Alternatively, an IDFT/DFT period applied to each symbol of the first field may be expressed to be N (=4) times shorter than the IDFT/DFT period applied to each data symbol of the second field. That is, the IDFT/DFT length applied to each symbol of the first field of the HE PPDU may be expressed as 3.2 μs and the IDFT/DFT length applied to each symbol of the second field of the HE PPDU may be expressed as 3.2 μs*4 (=12.8 μs). The length of the OFDM symbol may be a value acquired by adding the length of a guard interval (GI) to the IDFT/DFT length. The length of the GI may have various values such as 0.4 μs, 0.8 μs, 1.6 μs, 2.4 μs, and 3.2 μs.

For simplicity in the description, in FIG. 7, it is expressed that a frequency band used by the first field and a frequency band used by the second field accurately coincide with each other, but both frequency bands may not completely coincide with each other, in actual. For example, a primary band of the first field (L-STF, L-LTF, L-SIG, HE-SIG-A, and HE-SIG-B) corresponding to the first frequency band may be the same as the most portions of a frequency band of the second field (HE-STF, HE-LTF, and Data), but boundary surfaces of the respective frequency bands may not coincide with each other. As illustrated in FIGS. 4 to 6, since multiple null subcarriers, DC tones, guard tones, and the like are inserted during arranging the RUs, it may be difficult to accurately adjust the boundary surfaces.

The user (e.g., a receiving station) may receive the HE-SIG-A 730 and may be instructed to receive the downlink PPDU based on the HE-SIG-A 730. In this case, the STA may perform decoding based on the FFT size changed from the HE-STF 750 and the field after the HE-STF 750. On the contrary, when the STA may not be instructed to receive the downlink PPDU based on the HE-SIG-A 730, the STA may stop the decoding and configure a network allocation vector (NAV). A cyclic prefix (CP) of the HE-STF 750 may have a larger size than the CP of another field and the during the CP period, the STA may perform the decoding for the downlink PPDU by changing the FFT size.

Hereinafter, in the embodiment of the present disclosure, data (alternatively, or a frame) which the AP transmits to the STA may be expressed as a terms called downlink data (alternatively, a downlink frame) and data (alternatively, a frame) which the STA transmits to the AP may be expressed as a term called uplink data (alternatively, an uplink frame). Further, transmission from the AP to the STA may be expressed as downlink transmission and transmission from the STA to the AP may be expressed as a term called uplink transmission.

In addition, a PHY protocol data unit (PPDU), a frame, and data transmitted through the downlink transmission may be expressed as terms such as a downlink PPDU, a downlink frame, and downlink data, respectively. The PPDU may be a data unit including a PPDU header and a physical layer service data unit (PSDU) (alternatively, a MAC protocol data unit (MPDU)). The PPDU header may include a PHY header and a PHY preamble and the PSDU (alternatively, MPDU) may include the frame or indicate the frame (alternatively, an information unit of the MAC layer) or be a data unit indicating the frame. The PHY header may be expressed as a physical layer convergence protocol (PLCP) header as another term and the PHY preamble may be expressed as a PLCP preamble as another term.

Further, a PPDU, a frame, and data transmitted through the uplink transmission may be expressed as terms such as an uplink PPDU, an uplink frame, and uplink data, respectively.

In the wireless LAN system to which the embodiment of the present description is applied, the total bandwidth may be used for downlink transmission to one STA and uplink transmission to one STA. Further, in the wireless LAN system to which the embodiment of the present description is applied, the AP may perform downlink (DL) multi-user (MU) transmission based on multiple input multiple output (MU MIMO) and the transmission may be expressed as a term called DL MU MIMO transmission.

In addition, in the wireless LAN system according to the embodiment, an orthogonal frequency division multiple access (OFDMA) based transmission method is preferably supported for the uplink transmission and/or downlink transmission. That is, data units (e.g., RUs) corresponding to different frequency resources are allocated to the user to perform uplink/downlink communication. In detail, in the wireless LAN system according to the embodiment, the AP may perform the DL MU transmission based on the OFDMA and the transmission may be expressed as a term called DL MU OFDMA transmission. When the DL MU OFDMA transmission is performed, the AP may transmit the downlink data (alternatively, the downlink frame and the downlink PPDU) to the plurality of respective STAs through the plurality of respective frequency resources on an overlapped time resource. The plurality of frequency resources may be a plurality of subbands (alternatively, sub channels) or a plurality of resource units (RUs). The DL MU OFDMA transmission may be used together with the DL MU MIMO transmission. For example, the DL MU MIMO transmission based on a plurality of space-time streams (alternatively, spatial streams) may be performed on a specific subband (alternatively, sub channel) allocated for the DL MU OFDMA transmission.

Further, in the wireless LAN system according to the embodiment, uplink multi-user (UL MU) transmission in which the plurality of STAs transmits data to the AP on the same time resource may be supported. Uplink transmission on the overlapped time resource by the plurality of respective STAs may be performed on a frequency domain or a spatial domain.

When the uplink transmission by the plurality of respective STAs is performed on the frequency domain, different frequency resources may be allocated to the plurality of respective STAs as uplink transmission resources based on the OFDMA. The different frequency resources may be different subbands (alternatively, sub channels) or different resources units (RUs). The plurality of respective STAs may transmit uplink data to the AP through different frequency resources. The transmission method through the different frequency resources may be expressed as a term called a UL MU OFDMA transmission method.

When the uplink transmission by the plurality of respective STAs is performed on the spatial domain, different time-space streams (alternatively, spatial streams) may be allocated to the plurality of respective STAs and the plurality of respective STAs may transmit the uplink data to the AP through the different time-space streams. The transmission method through the different spatial streams may be expressed as a term called a UL MU MIMO transmission method.

The UL MU OFDMA transmission and the UL MU MIMO transmission may be used together with each other. For example, the UL MU MIMO transmission based on the plurality of space-time streams (alternatively, spatial streams) may be performed on a specific subband (alternatively, sub channel) allocated for the UL MU OFDMA transmission.

In the legacy wireless LAN system which does not support the MU OFDMA transmission, a multi-channel allocation method is used for allocating a wider bandwidth (e.g., a 20 MHz excess bandwidth) to one terminal. When a channel unit is 20 MHz, multiple channels may include a plurality of 20 MHz channels. In the multi-channel allocation method, a primary channel rule is used to allocate the wider bandwidth to the terminal. When the primary channel rule is used, there is a limit for allocating the wider bandwidth to the terminal. In detail, according to the primary channel rule, when a secondary channel adjacent to a primary channel is used in an overlapped BSS (OBSS) and is thus busy, the STA may use remaining channels other than the primary channel. Therefore, since the STA may transmit the frame only to the primary channel, the STA receives a limit for transmission of the frame through the multiple channels. That is, in the legacy wireless LAN system, the primary channel rule used for allocating the multiple channels may be a large limit in obtaining a high throughput by operating the wider bandwidth in a current wireless LAN environment in which the OBSS is not small.

In order to solve the problem, in the embodiment, a wireless LAN system is disclosed, which supports the OFDMA technology. That is, the OFDMA technique may be applied to at least one of downlink and uplink. Further, the MU-MIMO technique may be additionally applied to at least one of downlink and uplink. When the OFDMA technique is used, the multiple channels may be simultaneously used by not one terminal but multiple terminals without the limit by the primary channel rule. Therefore, the wider bandwidth may be operated to improve efficiency of operating a wireless resource.

As described above, in case the uplink transmission performed by each of the multiple STAs (e.g., non-AP STAs) is performed within the frequency domain, the AP may allocate different frequency resources respective to each of the multiple STAs as uplink transmission resources based on OFDMA. Additionally, as described above, the frequency resources each being different from one another may correspond to different subbands (or sub-channels) or different resource units (RUs).

The different frequency resources respective to each of the multiple STAs are indicated through a trigger frame.

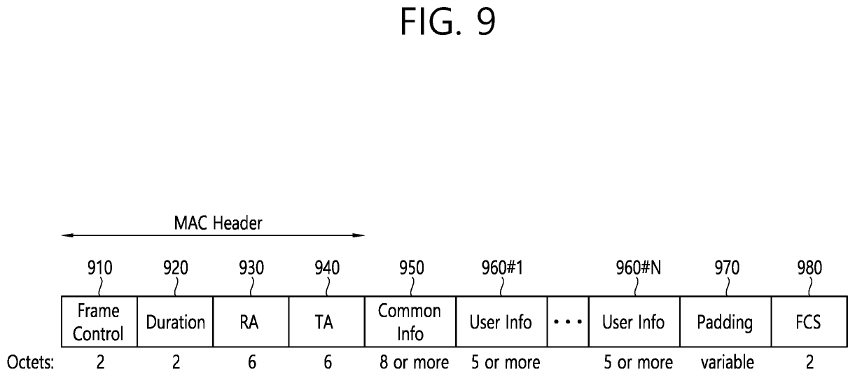

FIG. 9 illustrates an example of a trigger frame. The trigger frame of FIG. 9 allocates resources for uplink multiple-user (MU) transmission and may be transmitted from the AP. The trigger frame may be configured as a MAC frame and may be included in the PPDU. For example, the trigger frame may be transmitted through the PPDU shown in FIG. 3, through the legacy PPDU shown in FIG. 2, or through a certain PPDU, which is newly designed for the corresponding trigger frame. In case the trigger frame is transmitted through the PPDU of FIG. 3, the trigger frame may be included in the data field shown in the drawing.

Each of the fields shown in FIG. 9 may be partially omitted, or other fields may be added. Moreover, the length of each field may be varied differently as shown in the drawing.

A Frame Control field 910 shown in FIG. 9 may include information related to a version of the MAC protocol and other additional control information, and a Duration field 920 may include time information for configuring a NAV or information related to an identifier (e.g., AID) of the user equipment.

Also, the RA field 930 includes address information of a receiving STA of the corresponding trigger frame and may be omitted if necessary. The TA field 940 includes address information of a STA triggering the corresponding trigger frame (for example, an AP), and the common information field 950 includes common control information applied to a receiving STA that receives the corresponding trigger frame. For example, a field indicating the length of the L-SIG field of the UL PPDU transmitted in response to the corresponding trigger frame or information controlling the content of the SIG-A field (namely, the HE-SIG-A field) of the UL PPDU transmitted in response to the corresponding trigger frame may be included. Also, as common control information, information on the length of the CP of the UP PPDU transmitted in response to the corresponding trigger frame or information on the length of the LTF field may be included.

Also, it is preferable to include a per user information field (960#1 to 960#N) corresponding to the number of receiving STAs that receive the trigger frame of FIG. 9. The per user information field may be referred to as an “RU allocation field”.

Also, the trigger frame of FIG. 9 may include a padding field 970 and a frame check sequence field 980.

It is preferable that each of the per user information fields (960#1 to 960#N) shown in FIG. 9 includes a plurality of subfields.

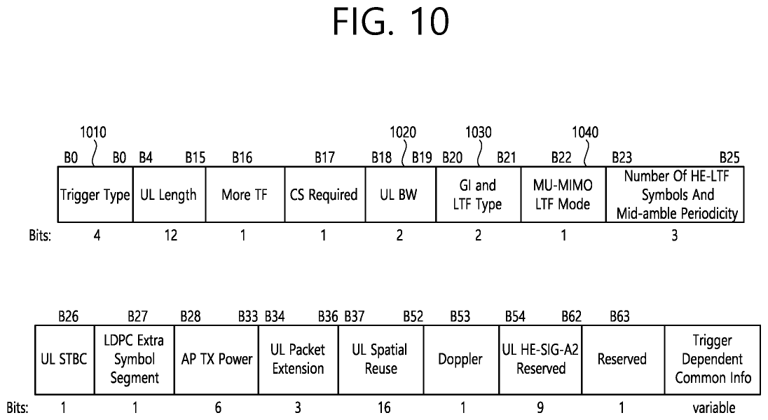

FIG. 10 illustrates an example of a common information field. Among the sub-fields of FIG. 10, some may be omitted, and other additional sub-fields may also be added. Additionally, the length of each of the sub-fields shown in the drawing may be varied.

The trigger type field 1010 of FIG. 10 may indicate a trigger frame variant and encoding of the trigger frame variant. The trigger type field 1010 may be defined as follows.

TABLE 4

| Trigger Type | |
|---|---|
| subfield value | Trigger frame variant |
| 0 | Basic |
| 1 | Beamforming Report Poll (BFRP) |
| 2 | MU-BAR |
| 3 | MU-RTS |
| 4 | Buffer Status Report Poll (BSRP) |
| 5 | GCR MU-BAR |
| 6 | Bandwidth Query Report Poll (BQRP) |
| 7 | NDP Feedback Report Poll (NFRP) |
| 8-15 | Reserved |

The UL BW field 1020 of FIG. 10 indicates bandwidth in the HE-SIG-A field of an HE Trigger Based (TB) PPDU. The UL BW field 1020 may be defined as follows.

TABLE 5

| UL BW | |
|---|---|
| subfield value | Description |
| 0 | 20 MHz |
| 1 | 40 MHz |
| 2 | 80 MHz |
| 3 | 80 + 80 MHz or 160 MHz |

The Guard Interval (GI) and LTF type fields 1030 of FIG. 10 indicate the GI and HE-LTF type of the HE TB PPDU response. The GI and LTF type field 1030 may be defined as follows.

TABLE 6

| GI And LTF | |
|---|---|
| field value | Description |
| 0 | 1x HE-LTF + 1.6 μs GI |
| 1 | 2x HE-LTF + 1.6 μs GI |
| 2 | 4x HE- LTF + 3.2 μs GI(#15968) |
| 3 | Reserved |

Also, when the GI and LTF type fields 1030 have a value of 2 or 3, the MU-MIMO LTF mode field 1040 of FIG. 10 indicates the LTF mode of a UL MU-MIMO HE TB PPDU response. At this time, the MU-MIMO LTF mode field 1040 may be defined as follows.

If the trigger frame allocates an RU that occupies the whole HE TB PPDU bandwidth and the RU is allocated to one or more STAs, the MU-MIMO LTF mode field 1040 indicates one of an HE single stream pilot HE-LTF mode or an HE masked HE-LTF sequence mode.

If the trigger frame does not allocate an RU that occupies the whole HE TB PPDU bandwidth and the RU is not allocated to one or more STAs, the MU-MIMO LTF mode field 1040 indicates the HE single stream pilot HE-LTF mode. The MU-MIMO LTF mode field 1040 may be defined as follows.

TABLE 7

| MU-MIMO LTF | |
|---|---|
| subfield value | Description |
| 0 | HE single stream pilot HE-LTF mode |
| 1 | HE masked HE-LTF sequence mode |

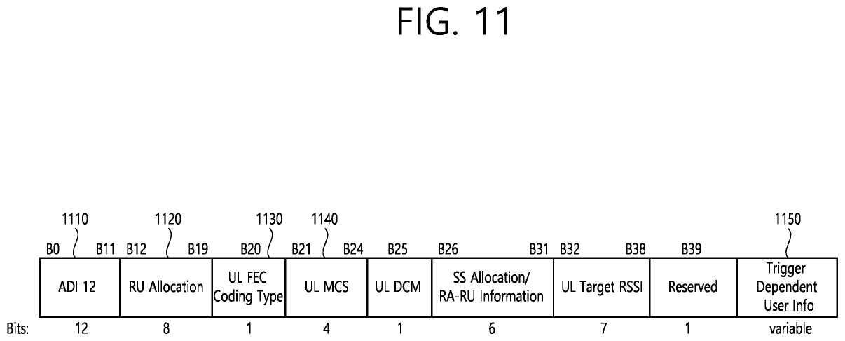

FIG. 11 illustrates an example of a sub-field being included in a per user information field. Among the sub-fields of FIG. 11, some may be omitted, and other additional sub-fields may also be added. Additionally, the length of each of the sub-fields shown in the drawing may be varied.

The User Identifier field of FIG. 11 (or AID12 field, 1110) indicates the identifier of a STA (namely, a receiving STA) corresponding to per user information, where an example of the identifier may be the whole or part of the AID.

Also, an RU Allocation field 1120 may be included. In other words, when a receiving STA identified by the User Identifier field 1110 transmits a UL PPDU in response to the trigger frame of FIG. 9, the corresponding UL PPDU is transmitted through an RU indicated by the RU Allocation field 1120. In this case, it is preferable that the RU indicated by the RU Allocation field 1120 corresponds to the RUs shown in FIGS. 4, 5, and 6. A specific structure of the RU Allocation field 1120 will be described later.

The subfield of FIG. 11 may include a (UL FEC) coding type field 1130. The coding type field 1130 may indicate the coding type of an uplink PPDU transmitted in response to the trigger frame of FIG. 9. For example, when BCC coding is applied to the uplink PPDU, the coding type field 1130 may be set to ‘1’, and when LDPC coding is applied, the coding type field 1130 may be set to ‘0’.

Additionally, the sub-field of FIG. 11 may include a UL MCS field 1140. The MCS field 1140 may indicate a MCS scheme being applied to the uplink PPDU that is transmitted in response to the trigger frame of FIG. 9.

Also, the subfield of FIG. 11 may include a Trigger Dependent User Info field 1150. When the Trigger Type field 1010 of FIG. 10 indicates a basic trigger variant, the Trigger Dependent User Info field 1150 may include an MPDU MU Spacing Factor subfield (2 bits), a TID Aggregate Limit subfield (3 bits), a Reserved field (1 bit), and a Preferred AC subfield (2 bits).

Hereinafter, the present disclosure proposes an example of improving a control field included in a PPDU. The control field improved according to the present disclosure includes a first control field including control information required to interpret the PPDU and a second control field including control information for demodulate the data field of the PPDU. The first and second control fields may be used for various fields. For example, the first control field may be the HE-SIG-A 730 of FIG. 7, and the second control field may be the HE-SIG-B 740 shown in FIGS. 7 and 8.

Hereinafter, a specific example of improving the first or the second control field will be described.

In the following example, a control identifier inserted to the first control field or a second control field is proposed. The size of the control identifier may vary, which, for example, may be implemented with 1-bit information.

The control identifier (for example, a 1-bit identifier) may indicate whether a 242-type RU is allocated when, for example, 20 MHz transmission is performed. As shown in FIGS. 4 to 6, RUs of various sizes may be used. These RUs may be divided broadly into two types. For example, all of the RUs shown in FIGS. 4 to 6 may be classified into 26-type RUs and 242-type RUs. For example, a 26-type RU may include a 26-RU, a 52-RU, and a 106-RU while a 242-type RU may include a 242-RU, a 484-RU, and a larger RU.

The control identifier (for example, a 1-bit identifier) may indicate that a 242-type RU has been used. In other words, the control identifier may indicate that a 242-RU, a 484-RU, or a 996-RU is included. If the transmission frequency band in which a PPDU is transmitted has a bandwidth of 20 MHz, a 242-RU is a single RU corresponding to the full bandwidth of the transmission frequency band (namely, 20 MHz). Accordingly, the control identifier (for example, 1-bit identifier) may indicate whether a single RU corresponding to the full bandwidth of the transmission frequency band is allocated.

For example, if the transmission frequency band has a bandwidth of 40 MHz, the control identifier (for example, a 1-bit identifier) may indicate whether a single RU corresponding to the full bandwidth (namely, bandwidth of 40 MHz) of the transmission frequency band has been allocated. In other words, the control identifier may indicate whether a 484-RU has been allocated for transmission in the frequency band with a bandwidth of 40 MHz.

For example, if the transmission frequency band has a bandwidth of 80 MHz, the control identifier (for example, a 1-bit identifier) may indicate whether a single RU corresponding to the full bandwidth (namely, bandwidth of 80 MHz) of the transmission frequency band has been allocated. In other words, the control identifier may indicate whether a 996-RU has been allocated for transmission in the frequency band with a bandwidth of 80 MHz.

Various technical effects may be achieved through the control identifier (for example, 1-bit identifier).

First of all, when a single RU corresponding to the full bandwidth of the transmission frequency band is allocated through the control identifier (for example, a 1-bit identifier), allocation information of the RU may be omitted. In other words, since only one RU rather than a plurality of RUs is allocated over the whole transmission frequency band, allocation information of the RU may be omitted deliberately.

Also, the control identifier may be used as signaling for full bandwidth MU-MIMO. For example, when a single RU is allocated over the full bandwidth of the transmission frequency band, multiple users may be allocated to the corresponding single RU. In other words, even though signals for each user are not distinctive in the temporal and spatial domains, other techniques (for example, spatial multiplexing) may be used to multiplex the signals for multiple users in the same, single RU. Accordingly, the control identifier (for example, a 1-bit identifier) may also be used to indicate whether to use the full bandwidth MU-MIMO described above.

The common field included in the second control field (HE-SIG-B, 740) may include an RU allocation subfield. According to the PPDU bandwidth, the common field may include a plurality of RU allocation subfields (including N RU allocation subfields). The format of the common field may be defined as follows.

TABLE 8

| | Number | |
|---|---|---|
| Subfield | of bits | Description |
| RU Allocation | N × 8 | Indicates the RU assignment to be used in the data portion in |
| | | the frequency domain. It also indicates the number of users in |
| | | each RU. For RUs of size greater than or equal to 106-tones |
| | | that support MU-MIMO, it indicates the number of users |
| | | multiplexed using MU-MIMO. |
| | | Consists of N RU Allocation subfields: |
| | | N = 1 for a 20 MHz and a 40 MHz HE MU PPDU |
| | | N = 2 for an 80 MHz HE MU PPDU |
| | | N = 4 for a 160 MHz or 80 + 80 MHz HE MU PPDU |
| Center 26-tone RU | 1 | This field is present only if(#15510) the value of the |
| | | Bandwidth field of HE-SIG-A field in an HE MU PPDU is |
| | | set to greater than 1. |
| | | If the Bandwidth field of the HE-SIG-A field in an HE MU |
| | | PPDU is set to 2, 4 or 5 for 80 MHz: |
| | | Set to 1 to indicate that a user is allocated to the center 26- |
| | | tone RU (see FIG. 28-7 (RU locations in an 80 MHz HE |
| | | PPDU(#16528))); otherwise, set to 0. The same value is |
| | | applied to both HE-SIG-B content channels. |
| | | If the Bandwidth field of the HE-SIG-A field in an HE MU |
| | | PPDU is set to 3, 6 or 7 for 160 MHz or 80 + 80 MHz: |
| | | For HE-SIG-B content channel 1, set to 1 to indicate that a |
| | | user is allocated to the center 26-tone RU of the lower |
| | | frequency 80 MHz; otherwise, set to 0. |
| | | For HE-SIG-B content channel 2, set to 1 to indicate that a |
| | | user is allocated to the center 26-tone RU of the higher |
| | | frequency 80 MHz; otherwise, set to 0. |
| CRC | 4 | See 28.3.10.7.3 (CRC computation) |
| Tail | 6 | Used to terminate the trellis of the convolutional decoder. |
| | | Set to 0 |

The RU allocation subfield included in the common field of the HE-SIG-B may be configured with 8 bits and may indicate as follows with respect to 20 MHz PPDU bandwidth. RUs to be used as a data portion in the frequency domain are allocated using an index for RU size and disposition in the frequency domain. The mapping between an 8-bit RU allocation subfield for RU allocation and the number of users per RU may be defined as follows.

TABLE 9

| 8 bits indices | | | | | | | | | | |
|---|---|---|---|---|---|---|---|---|---|---|
| (B7 B6 B5 B4 | | | | | | | | | | Number |
| B3 B2 B1 B0) | #1 | #2 | #3 | #4 | #5 | #6 | #7 | #8 | #9 | of entries |
| 00000000 | 26 | 26 | 26 | 26 | 26 | 26 | 26 | 26 | 26 | 1 |

| | | | | | | | | | |
|---|---|---|---|---|---|---|---|---|---|
| 00000001 | 26 | 26 | 26 | 26 | 26 | 26 | 26 | 52 | 1 |

| | | | | | | | | | |
|---|---|---|---|---|---|---|---|---|---|
| 00000010 | 26 | 26 | 26 | 26 | 26 | 52 | 26 | 26 | 1 |

| | | | | | | | | |
|---|---|---|---|---|---|---|---|---|
| 00000011 | 26 | 26 | 26 | 26 | 26 | 52 | 52 | 1 |

| | | | | | | | | | |
|---|---|---|---|---|---|---|---|---|---|
| 00000100 | 26 | 26 | 52 | 26 | 26 | 26 | 26 | 26 | 1 |

| | | | | | | | | |
|---|---|---|---|---|---|---|---|---|
| 00000101 | 26 | 26 | 52 | 26 | 26 | 26 | 52 | 1 |

| | | | | | | | | |
|---|---|---|---|---|---|---|---|---|
| 00000110 | 26 | 26 | 52 | 26 | 52 | 26 | 26 | 1 |

| | | | | | | | |
|---|---|---|---|---|---|---|---|
| 00000111 | 26 | 26 | 52 | 26 | 52 | 52 | 1 |

| | | | | | | | | | |
|---|---|---|---|---|---|---|---|---|---|
| 00001000 | 52 | 26 | 26 | 26 | 26 | 26 | 26 | 26 | 1 |

| | | | | | | | | |
|---|---|---|---|---|---|---|---|---|
| 00001001 | 52 | 26 | 26 | 26 | 26 | 26 | 52 | 1 |

| | | | | | | | | |
|---|---|---|---|---|---|---|---|---|
| 00001010 | 52 | 26 | 26 | 26 | 52 | 26 | 26 | 1 |

| | | | | | | | |
|---|---|---|---|---|---|---|---|
| 00001011 | 52 | 26 | 26 | 26 | 52 | 52 | 1 |

| | | | | | | | | |
|---|---|---|---|---|---|---|---|---|
| 00001100 | 52 | 52 | 26 | 26 | 26 | 26 | 26 | 1 |

| | | | | | | | |
|---|---|---|---|---|---|---|---|
| 00001101 | 52 | 52 | 26 | 26 | 26 | 52 | 1 |

| | | | | | | | |
|---|---|---|---|---|---|---|---|
| 00001110 | 52 | 52 | 26 | 52 | 26 | 26 | 1 |

| | | | | | | |
|---|---|---|---|---|---|---|
| 00001111 | 52 | 52 | 26 | 52 | 52 | 1 |

| | | | | | |
|---|---|---|---|---|---|
| 00010y₂y₁y₀ | 52 | 52 | — | 106 | 8 |

| | | | | | |
|---|---|---|---|---|---|
| 00011y₂y₁y₀ | 106 | — | 52 | 52 | 8 |

| | | | | | | | |
|---|---|---|---|---|---|---|---|
| 00100y₂y₁y₀ | 26 | 26 | 26 | 26 | 26 | 106 | 8 |

| | | | | | | |
|---|---|---|---|---|---|---|
| 00101y₂y₁y₀ | 26 | 26 | 52 | 26 | 106 | 8 |

| | | | | | | |
|---|---|---|---|---|---|---|
| 00110y₂y₁y₀ | 52 | 26 | 26 | 26 | 106 | 8 |

| | | | | | |
|---|---|---|---|---|---|
| 00111y₂y₁y₀ | 52 | 52 | 26 | 106 | 8 |

| | | | | | | | |
|---|---|---|---|---|---|---|---|
| 01000y₂y₁y₀ | 106 | 26 | 26 | 26 | 26 | 26 | 8 |

| | | | | | | |
|---|---|---|---|---|---|---|
| 01001y₂y₁y₀ | 106 | 26 | 26 | 26 | 52 | 8 |

| | | | | | | |
|---|---|---|---|---|---|---|
| 01010y₂y₁y₀ | 106 | 26 | 52 | 26 | 26 | 8 |

| 01011y₂y₁y₀ | 106 | | 26 | 52 | 52 | 8 |
|---|---|---|---|---|---|---|
| 0110y₁y₀z₁z₀ | 106 | | — | 106 | | 16 |
| 01110000 | 52 | 52 | — | 52 | 52 | 1 |

| 01110001 | 242-tone RU empty | | | 1 |
|---|---|---|---|---|
| 01110010 | 484-tone RU with zero User fields | | | 1 |
| | indicated in this RU Allocation subfield of | | | |
| | the HE-SIG-B content channel | | | |
| 01110011 | 996-tone RU with zero User fields | | | 1 |
| | indicated in this RU Allocation subfield of | | | |
| | the HE-SIG-B content channel | | | |
| 011101x₁x₀ | Reserved | | | 4 |
| 01111y₂y₁y₀ | Reserved | | | 8 |
| 10y₂y₁y₀z₂z₁z₀ | 106 | 26 | 106 | 64 |

| | | |
|---|---|---|
| 11000y₂y₁y₀ | 242 | 8 |
| 11001y₂y₁y₀ | 484 | 8 |
| 11010y₂y₁y₀ | 996 | 8 |
| 11011y₂y₁y₀ | Reserved | 8 |
| 111x₄x₃x₂x₁x₀ | Reserved | 32 |

If(#Ed) signaling RUs of size greeater than 242 subcarriers, y₂y₁y₀ = 000 − 111 indicates number of User fields in the HE-SIG-B content channel that contains the corresponding 8-bit RU Allocation subfield. Otherwise, y₂y₁y₀ = 000 − 111 indicates number of STAs multiplexed in the 106-tone RU, 242-tone RU or the lower frequency 106-tone RU if there are two 106-tone RUs and one 26-tone RU is assigned between two 106-tone RUs. The binary vector y₂y₁y₀ indicates 2² × y₂ + 2¹ × y₁ + y₀ + 1 STAs multiplexed the RU.
z₂z₁z₀ = 000 − 111 indicates number of STAs multiplexed in the higher frequency 106-tone RU if there are two 106-tone RUs and one 26-tone RU is assigned between two 106-tone RUs. The binary vector z₂z₁z₀ indicates 2² × z₂ + 2¹ × z₁ + z₀ + 1 STAs multiplexed in the RU.
Similarly, y₁y₀ = 00 − 11 indicates number of STAs multiplexed in the lower frequency 106-tone RU. The binary vector y₁y₀ indicates 2¹ × y₁ + y₀ + 1 STAs multiplexed in the RU.
Similarly, z₁z₀ = 00 − 11 indicates the numver of STAs multiplexed in the higher frequency 106-tone RU. The binary vector z₁z₀ indicates 2¹ × z₁ + z₀ + 1 STAs multiplexed in the RU.
#1 to #9 (from left to the right) is ordered in increasing order of the absolute frequency.
x₁x₀ = 00 − 11, x₄x₃x₂x₁x₀ = 00000 − 11111
‘—’ means no STA in that RU.

The user-specific field included in the second control field (HE-SIG-B, 740) may include a user field, a CRC field, and a Tail field. The format of the user-specific field may be defined as follows.

TABLE 10

| | Number | |
|---|---|---|
| Subfield | of bits | Description |
| User field | N × 21 | The User field format for a non-MU-MIMO allocation is |
| | | defined in Table 28-26 (User field format for a non-MU- |
| | | MIMO allocation). The User field format for a MU-MIMO |
| | | allocation is defined in Table 28-27 (User field for an MU- |
| | | MIMO allocation). |
| | | N = 1 if it is the last User Block field, and if there is only one |
| | | user in the last User Block field. |
| | | N = 2 otherwise. |
| CRC | 4 | The CRC is calculated over bits 0 to 20 for a User Block field |
| | | that contains one User field, and bits 0 to 41 for a User Block |
| | | field that contains two User fields. See 28.3.10.7.3 (CRC |
| | | computation). |
| Tail | 6 | Used to terminate the trellis of the convolutional decoder. |
| | | Set to 0. |

Also, the user-specific field of the HE-SIG-B is composed of a plurality of user fields. The plurality of user fields are located after the common field of the HE-SIG-B. The location of the RU allocation subfield of the common field and that of the user field of the user-specific field are used together to identify an RU used for transmitting data of a STA. A plurality of RUs designated as a single STA are now allowed in the user-specific field. Therefore, signaling that allows a STA to decode its own data is transmitted only in one user field.

As an example, it may be assumed that the RU allocation subfield is configured with 8 bits of 01000010 to indicate that five 26-tone RUs are arranged next to one 106-tone RU and three user fields are included in the 106-tone RU. At this time, the 106-tone RU may support multiplexing of the three users. This example may indicate that eight user fields included in the user-specific field are mapped to six RUs, the first three user fields are allocated according to the MU-MIMO scheme in the first 106-tone RU, and the remaining five user fields are allocated to each of the five 26-tone RUs.

A user field included in the user-specific field of the HE-SIG-B may be defined as follows. First, the user field for non-MU-MIMO allocation is as follows.

TABLE 12

| | | Number | |
|---|---|---|---|
| Bit | Subfield | of bits | Description |
| B0-B10 | STA-ID | 11 | Set to a value of the element indicated from TXVECTOR |
| | | | parameter STA_ID_LIST (see 27.11.1 |
| | | | (STA_ID_LIST)). |
| B11-B13 | NSTS | 3 | Number of space-time streams. |
| | | | Set to the number of space-time streams minus 1. |
| B14 | Beam- | 1 | Use of transmit beamforming. |
| | formed(#16038) | | Set to 1 if a beamforming steering matrix is applied to |
| | | | the waveform in an SU transmission. |
| | | | Set to 0 otherwise. |
| B15-B18 | MCS | 4 | Modulation and coding scheme |
| | | | Set to n for MCSn, where n = 0, 1, 2 . . . , 11 |
| | | | Values 12 to 15 are reserved |
| B19 | DCM | 1 | Indicates whether or not DCM is used. |
| | | | Set to 1 to indicate that the payload(#Ed) of the |
| | | | corresponding user of the HE MU PPDU is modulated |
| | | | with DCM for the MCS. |
| | | | Set to 0 to indicate that the payload of the |
| | | | corresponding user of the PPDU is not modulated with |
| | | | DCM for the MCS. |
| | | | NOTE-DCM is not applied in combination with |
| | | | STBC. (#15664) |
| B20 | Coding | 1 | Indicates whether BCC or LDPC is used. |
| | | | Set to 0 for BCC |
| | | | Set to 1 for LDPC |

NOTE
If the STA-ID subfield is set to 2046, then the other subfields can be set to arbitrary values. (#15946)

The user field for MU-MIMO allocation is as follows.

TABLE 13

| | | Number | |
|---|---|---|---|
| Bit | Subfield | of bits | Description |
| B0-B10 | STA-ID | 11 | Set to a value of element indicated from TXVECTOR |
| | | | parameter STA_ID_LIST (see 27.11.1 |
| | | | (STA_ID_LIST)). |
| B11-B14 | Spatial | 4 | Indicates the number of spatial streams for a STA in an |
| | Configuration | | MU-MIMO allocation (see Table 28-28 (Spatial |
| | | | Configuration subfield encoding)). |
| B15-B18 | MCS | 4 | Modulation and coding scheme. |
| | | | Set to n for MCSn, where n = 0, 1, 2, . . . , 11 |
| | | | Values 12 to 15 are reserved |
| B19 | Reserved | 1 | Reserved and set to 0 |
| B20 | Coding | 1 | Indicates whether BCC or LDPC is used. |
| | | | Set to 0 for BCC |
| | | | Set to 1 for LDPC |

NOTE
If the STA-ID subfield is set to 2046, then the other subfields can be set to arbitrary values. (#15946)

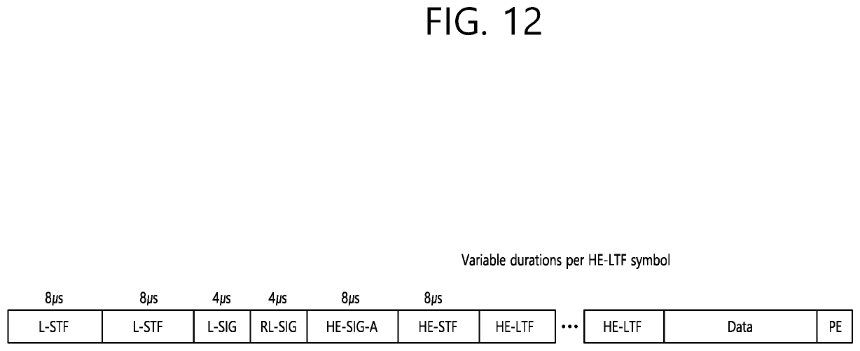

FIG. 12 illustrates an example of an HE TB PPDU. The PPDU of FIG. 12 illustrates an uplink PPDU transmitted in response to the trigger frame of FIG. 9. At least one STA receiving a trigger frame from an AP may check the common information field and the individual user information field of the trigger frame and may transmit an HE TB PPDU simultaneously with another STA which has received the trigger frame.

As shown in the figure, the PPDU of FIG. 12 includes various fields, each of which corresponds to the field shown in FIGS. 2, 3, and 7. Meanwhile, as shown in the figure, the HE TB PPDU (or uplink PPDU) of FIG. 12 may not include the HE-SIG-B field but only the HE-SIG-A field.

1. Power Saving Mechanism

The IEEE 802.11 standard provides power saving mechanism in order to increase the life of a WLAN STA. For power saving, the WLAN STA operates in two modes, which are an active mode and a sleep mode. The active mode refers to a mode in which a normal operation, such as frame transmission and reception and channel scanning, is possible. However, in the sleep mode, power consumption is extremely reduced, so that frame transmission and reception is impossible and channel scanning is also impossible.

According to the basic operation principle, the STA usually stays in the sleep mode and switches to the active mode to reduce power consumption.

As the WLAN STA operates in the sleep mode as long as possible, power consumption is reduced to increase the life of the WLAN STA. However, since frame transmission and reception is impossible in the sleep mode, the STA cannot just stay in the sleep mode for a long time. When the STA has a frame to transmit, the STA just switches from the sleep mode to the active mode to transmit the frame without causing any problem. However, when the STA is in the sleep mode and an AP has a frame to send to the STA, the STA can neither receive this frame nor recognize the presence of the frame to receive. Thus, the STA needs to often switch to the active mode and to operate in a reception mode in order to identify the presence of a frame to receive and to receive the frame. The AP needs to notify at that time the STA of the presence of a frame to transmit to the STA.

The WLAN STA periodically wakes up from the sleep mode and receives a beacon frame from the AP in order to identify the presence of a frame to receive. The AP notifies each STA of the presence of a frame to receive using a TIM element of the beacon frame. There are two kinds of TIM elements, a TIM used for indicating a unicast frame and a DTIM used to indicate a multicast/broadcast frame.

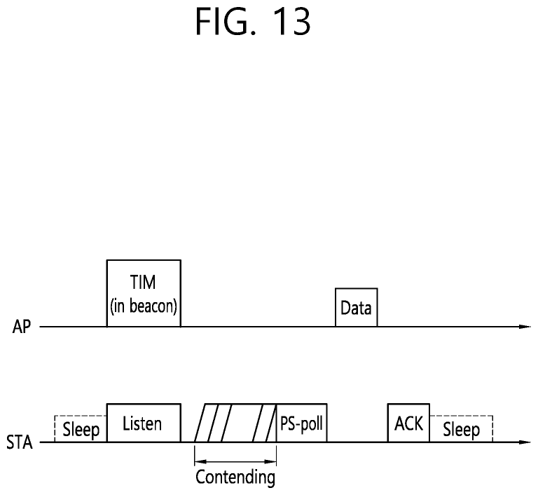

FIG. 13 illustrates an example of a power saving mechanism.

The STA which recognizes through the TIM element of the beacon frame that there is a frame that the AP has to transmit to the STA transmits a PS-Poll frame via contending. The AP receiving the PS-Poll frame selects an immediate response or deferred response to operate depending on a situation. In the immediate response, as illustrated in FIG. 13, a data frame is transmitted in SIFS immediately after the PS-Poll frame is received. When the data frame is normally received, the STA transmits an ACK frame in SIFS and switches back to the sleep mode.

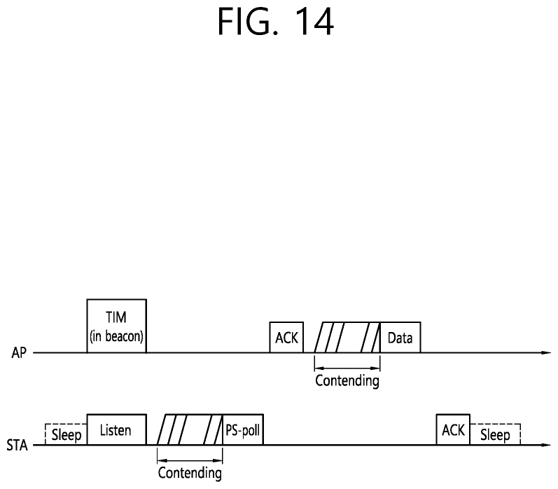

FIG. 14 illustrates another example of a power saving mechanism.

When the AP does not prepare a data frame for SIFS after receiving the PS-Poll frame, it selects the deferred response. As illustrated below in FIG. 14, after transmitting an ACK frame first, the AP transmits a data frame, when prepared, to the STA via contention. The STA which normally receives the data frame transmits an ACK frame and switches back to the sleep mode.

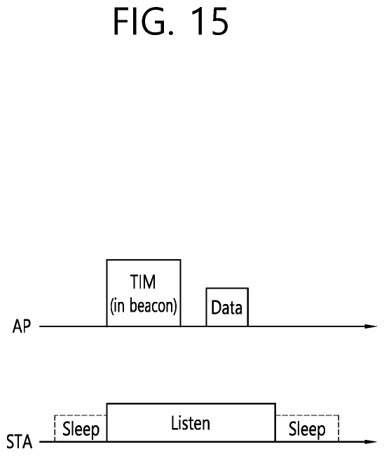

FIG. 15 illustrates still another example of a power saving mechanism.

Since the DTIM is used for a multicast/broadcast frame, a data frame is transmitted immediately after the beacon frame without transmitting and receiving a PS-Poll frame as illustrated below in FIG. 15, and all relevant STAs receives the data frame in the active mode.

The WLAN STA is allocated an association ID (AID) in association with the AP. Only an AID is used in one BSS and currently has a value of 1˜2007. Since 14 bits are allocated for an AID, up to 16383 can be used but 2008˜16383 are reserved.

2. Scanning Procedure

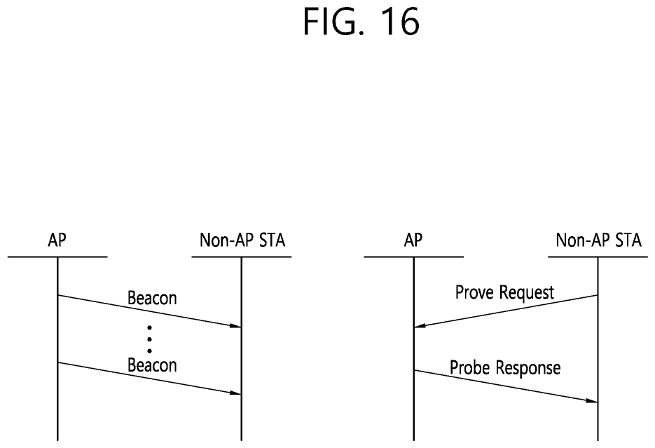

FIG. 16 illustrates an active/passive scanning procedure.

In the WLAN, a scanning procedure includes passive scanning and active scanning. Passive scanning is performed through a beacon frame periodically broadcast by an AP. An AP of a common WLAN broadcasts a beacon frame every 100 msecs and the beacon frame includes information on the current network. To obtain this information, a non-AP STA passively waits to receive a beacon frame in a corresponding channel. The non-AP STA receives the beacon frame to obtain the information on the network and finishes scanning in the corresponding channel. Since passive scanning is achieved when the non-AP STA only receives the beacon frame without transmitting other frames, it involves small overall overhead. However, scanning time increases in proportionate to a beacon frame period.

In active scanning, a non-AP STA actively broadcasts a probe request frame in a corresponding channel to request network information from all APs receiving this frame. An AP receiving the probe request frame waits for a random time to prevent frame collisions and loads network information onto the probe response frame to transmit the network information to the non-AP STA. The non-AP STA obtains the received network information to finish the scanning procedure. Active scanning can be finished within a relatively short time. However, an additional frame sequence is needed to increase overall network overhead.

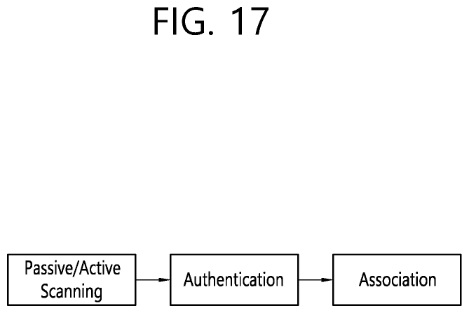

FIG. 17 illustrates a scanning/authentication/association procedure.

A non-AP STA which finishes scanning selects a network according to its own criteria and conducts authentication with a corresponding AP. An authentication procedure is performed by 2-way handshaking. The non-AP STA and the AP form an association through the authentication procedure via authentication.

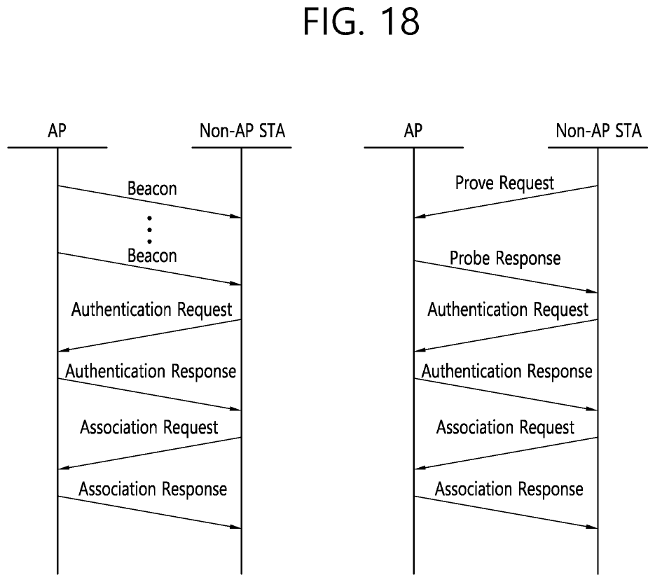

FIG. 18 is a flowchart illustrating a scanning/authentication/association procedure.

An association procedure is performed by 2-way handshaking. First, the non-AP STA transmits an association request frame to the AP. The transmitted association request frame includes capability information on the non-AP STA. Based on this information, the AP determines whether to support the non-AP STA. After determination, the AP transmits an association response frame, which includes information on acceptance or rejection of the association request and reasons for the acceptance or rejection and capability information on the AP, to the non-AP STA. If the association is properly formed, transmission/reception is normally performed. If the association is not formed, the non-AP STA reattempts the association procedure in view of the reasons or attempts an association with another AP.

3. PHY Transmission/Reception Procedure

A PHY transmission/reception procedure in Wi-Fi is as follows. Although examples for 11n and 11ax are illustrated for convenience, a similar procedure is used in 11g/ac.

That is, although a specific packet configuration method may be different, a general PHY transmission procedure is as follows. In the PHY transmission procedure, when a MAC protocol data unit (MPDU) or an aggregated MPDU (A-MPDU) is transmitted from a MAC layer, a PHY layer converts the MPDU or the A-MPDU into a single PHY service data unit (PSDU), inserts a preamble, a tail bit, and a padding bit (if needed) into the PSDU, and transmits the PSDU. This PSDU is referred to as a physical protocol data unit (PPDU).

A general PHY reception procedure is as follows. When energy detection and preamble detection (L/HT/VHT/HE-preamble detection by Wi-Fi version) are performed, information about a PSDU configuration is obtained from a PHY header (L/HT/VHT/HE-SIG), thereby reading a MAC header and data.

4. Embodiment Applicable to the Present Disclosure

While an existing Wi-Fi system operates in a 2.4 GHz band and in a 5 GHz band, a frequency policy for enabling the Wi-Fi system to operate also in a 6 GHz band has recently been under discussion. However, it is expected that a terminal to operate in the 6 GHz band will be limited to an 11ax terminal.

Extremely high throughput (EHT) techniques are under discussion as beyond-11ax requirements, among which multi-band aggregation is selected as a technical element for achieving high throughput. A proposed method relates to a procedure in which a specific band or channel is allocated only for EHT STAs and uplink transmission is performed only based on scheduling by an AP and an indication method therefor. According to the proposed method, it is possible to prevent legacy STAs from performing uplink transmission in the band and to control individual contentions between EHT STAs in the band, thus reducing the total number of contentions between STAs as compared to an existing technique and enabling efficient downlink and uplink transmissions. That is, efficiency in the band may be enhanced, thereby improving system throughput.

5. Proposed Embodiment

First, as a method for preventing legacy STAs from performing uplink transmission in a specific band or channel, a method of transmitting a beacon to be transmitted in the channel in a PPDU format newly defined according to EHT is proposed.

The newly defined PPDU format enables EHT STAs to recognize that a corresponding PPDU is an EHT PPDU through a newly defined packet clarification method. (The proposed method does not cover the details of packet clarification.) However, the legacy STAs including an 11ax STA cannot recognize that the PPDU is an EHT PPDU and thus cannot succeed in decoding. Therefore, the legacy STAs cannot successfully decode a beacon frame transmitted in the band or channel and cannot perform access to a corresponding BSS through passive scanning. However, the proposed method cannot prevent active scanning through a probe request frame. When the proposed method is applied in a 6 GHz band, since there is only an 11ax STA as a legacy STA in the 6 GHz band, the frequency of transmissions of a probe request frame for active scanning may be minimized.

Further, in the proposed method, even though receiving a probe request frame from the legacy STAs in a band or channel based only on scheduling by an AP, the AP does not transmit a probe response frame in the band or channel, thereby preventing access of the legacy STAs.

According to another proposed method, it is possible to prevent access such that a STA does not transmit a probe request frame in the specific band (e.g., 6 GHz). Accordingly, both an 11ax STA and an EHT STA may not perform active scanning in the 6 GHz band.

Further, in order to prevent individual contention-based uplink transmissions by EHT STAs in the band or channel, an indication method is required. An indication may be one bit, in which 0 may be defined as allowing contention-based uplink transmission and 1 may be defined as a constraint of allowing uplink transmission based only on scheduling by the AP.

For example, the indication may be defined as in the following table.

TABLE 14

| UL EDCA | |
|---|---|
| method | Meaning |
| 0 | Allowing UL EDCA transmission |
| 1 | Disallowing UL EDCA transmission |

Information illustrated in the table may be inserted into a beacon frame, may be inserted into a probe response frame only when transmitted by EHT STAs, or may be added to an association frame or an announcement frame. Alternatively, the indication method may also be applied to the legacy STAs. Although the legacy STAs include 11a/b/g/n/ac/ax STAs, since only an 11ax terminal can perform scheduling-based uplink transmission through a trigger frame, the legacy STAs may be limited to the 11ax terminal. Therefore, contention-based uplink transmission and uplink transmission based on scheduling by the AP may be selectively operated through the indication method.

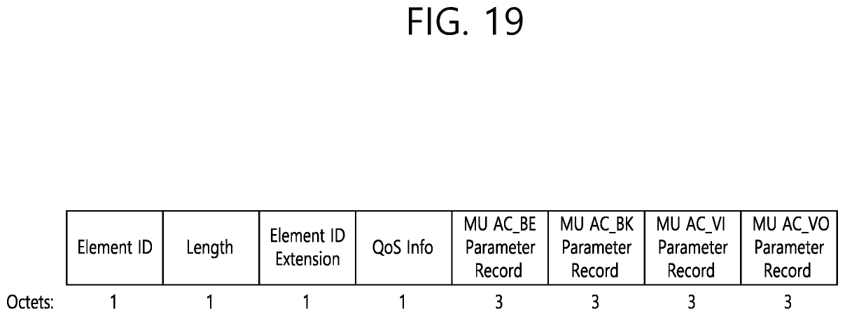

FIG. 19 illustrates the format of a MU EDCA parameter set element according to an embodiment.

Unlike the above indication method, a multi-user (MU) enhanced distributed channel access (EDCA) parameter set element defined in a beacon frame may be used. The MU EDCA parameter set element is illustrated in FIG. 19. The MU EDCA parameter set element optionally exists when dotl1HEOptionImplemented is true and a QoS capability element does not exist. On the contrary, when dotl1HEOptionImplemented is false and the QoS capability element exists, the MU EDCA parameter set element does not exist.

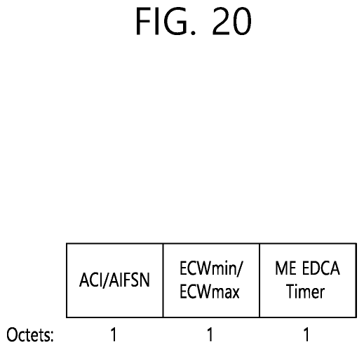

FIG. 20 illustrates the format of a MU AC parameter record field according to an embodiment.

MU AC_BE, MU AC_BK, MU AC_VI, and MU AC_VO parameter record fields are configured as illustrated in FIG. 20.

In an infrastructure BSS, a MU EDCA parameter set element is used by an AP to control EDCA from a non-AP HE STA as defined in an EDCA operation using an EDCA parameter. The MU EDCA parameter set element most recently received by the non-AP HE STA is used to update an appropriate management information base (MIB) value.

In 11ax, an access category index (ACI)/arbitration inter-frame space number (AIFSN) field is defined as follows.

Encoding of a subfield of the ACI/AIFSN field of FIG. 20 is defined in the EDCA parameter set element. However, when the value of the AIFSN field is 0, EDCA is deactivated for a period specified in a MU EDCA timer for a corresponding access category (AC).

That is, when AIFSN=0, EDCA is not performed for the period indicated by the MU EDCA timer. The proposed method disables EDCA in a specific band or BSS without restriction in period using a specific value of the MU EDCA timer.

For example, when the MU EDCA timer is configured with one octet and indicates 11111111, the EDCA is restricted in the band or BSS, in which uplink transmission based only on scheduling by an AP is allowed. Here, another specific value, such as 00000000, may be used as a MU EDCA timer value.

Encoding of a subfield of an ECWmin/ECWmax field of FIG. 20 is defined in the EDCA parameter set element.

A MU EDCA timer field of FIG. 20 indicates duration in 8-TU units for which the HE STA uses the MU EDCA parameter for the AC as defined in the EDCA operation using the MU EDCA parameter. Here, a value of 0 is reserved.

When UL EDCA transmission is not allowed as above, the STA does not perform EDCA in the band or channel and thus does not perform UL transmission. Therefore, for UL transmission by STAs, the AP may transmit a trigger frame. The trigger frame includes the IDs of the STAs to enable UL SU/MU transmission, and the STAs start UL transmission via an RU allocated after SIFS from the time of receiving the trigger frame.

That is, when UL EDCA transmission is not allowed, the STAs may receive only the trigger frame and may perform UL transmission only when the trigger frame includes the IDs thereof.

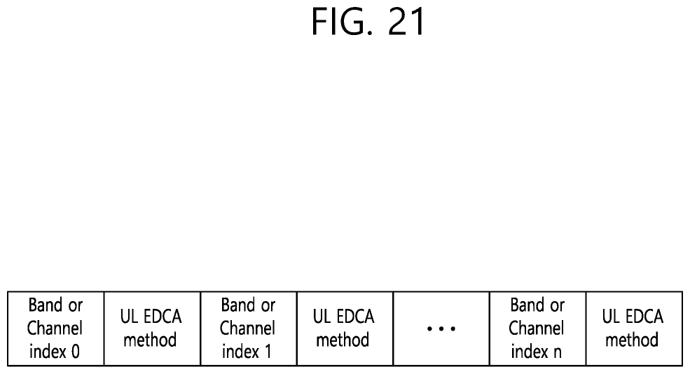

FIG. 21 illustrates an example of indicating a UL EDCA method for each multi-band or multi-channel according to an embodiment.

An EHT AP and EHT STAs can operate in a multi-band and can thus perform transmission by aggregating one or more channels. Thus, to apply the above indication method to a specific band or channel, the indication method needs to be defined for each band or channel. Therefore, it is possible to enable the indication for each band or channel as illustrated FIG. 21.

A band or channel index may configured with a channel set defined in an operating class or may be indicated by the same value as that for a band or channel defined in an operation element, or a UL EDCA method may be added to the operation element.

An operating class field and a channel field are used in a location indication channels sub-element of a location parameters element and a channel usage element. The operating class field and the channel field indicate an operating class and a channel.

The operating class field indicates an operating class value defined in Appendix E of the 802.11 specification. The operating class is interpreted as the context of a country specified in a beacon frame.

The channel field indicates a channel number and is interpreted as the context of an indicated operating class. The channel number is also defined in Appendix E of the 802.11 specification.

Hereinafter, the above-described embodiments will be described according to time.

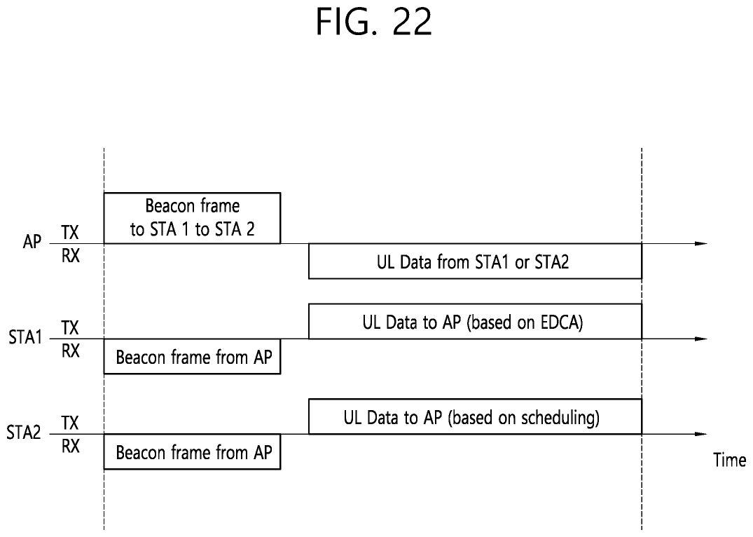

FIG. 22 illustrates a procedure for transmitting uplink data based on a beacon frame according to an embodiment.

In the embodiment of FIG. 22, it is assumed that STA 1 supports an 802.11ax or legacy WLAN system and STA 2 supports an EHT WLAN system.

Referring to FIG. 22, an AP transmits a beacon frame to STA 1 to STA 2. The beacon frame may be broadcast and may be transmitted in a first band or a second band. The first band is a 2.4 GHz or 5 GHz band, and the second band is a 6 GHz band. STA 1 and STA 2 may operate both in the first band and in the second band. However, a STA that supports only the legacy WLAN system cannot operate in the second band.

The embodiment of FIG. 22 corresponds to passive scanning since the beacon frame is transmitted. However, this embodiment may also include active scanning in which a STA transmits a probe request frame first and an AP transmits a probe response frame (not shown).

The beacon frame includes information about a transmission mode for uplink data for each band or channel. That is, whether uplink data is transmitted based on contention (EDCA) or scheduling in each band or channel is determined by the beacon frame.

FIG. 22 illustrates one embodiment of a transmission mode for uplink data.

For example, it may be determined by a beacon frame received by STA 1 that uplink data is transmitted in a specific band and a specific channel based on contention. Here, STA 1 transmits uplink data to the AP based on contention. STA 1 may identify whether the channel is idle until a backoff timer reaches 0 by performing EDCA, and may transmit the uplink data when the channel is idle.

In addition, it may be determined by a beacon frame received by STA 2 that uplink data is transmitted in a specific band and a specific channel based on scheduling. Here, STA 2 may receive a trigger frame from the AP (not shown) and may transmit uplink data based on scheduling information of the trigger frame. That is, the AP may control individual contention in the specific band and the specific channel according to this transmission mode, thus enabling efficient DL and UL transmissions.

The uplink data transmission by STA 1 and the uplink data transmission by STA 2 may not be performed at the same time. The AP may receive uplink data from STA 1 or STA 2 based on an uplink data transmission mode determined according to the beacon frame.

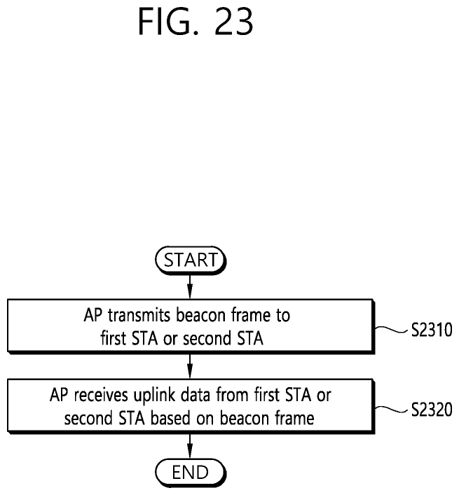

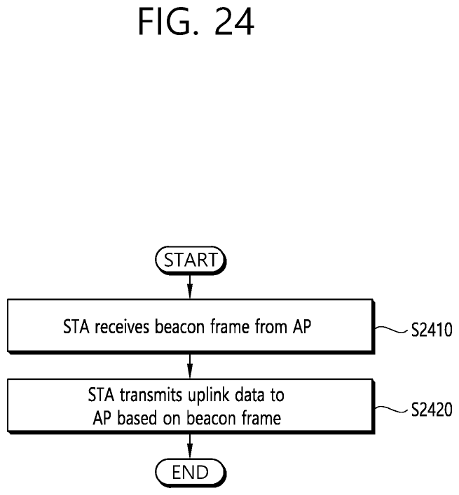

A scheduling transmission mode of the AP for a specific band will be described in detail with reference to FIG. 23 and FIG. 24.

FIG. 23 is a flowchart illustrating a procedure for an AP to receive uplink data according to an embodiment.

The embodiment of FIG. 23 may be performed in a network environment supporting a next-generation WLAN system. The next-generation WLAN system may be a WLAN system evolving from an 802.11ax system and may satisfy backward compatibility with the 802.11ax system.

The embodiment of FIG. 23 may be performed by a transmission device, and the transmission device may correspond to an access point (AP). In the embodiment of FIG. 23, a reception device may correspond to a STA (non-AP STA), wherein a first STA may support an 802.11ax WLAN system and a second STA may support an extremely high throughput (EHT) WLAN system.

In operation S2310, the AP transmits a beacon frame to the first STA or the second STA.

In operation S2320, the AP receives uplink data from the first STA or the second STA based on the beacon frame.

The beacon frame includes information about a transmission mode for the uplink data for each channel in a first band and each channel in a second band. When the information about the transmission mode for the uplink data is set to a first value, the uplink data is transmitted based on contention (that is, EDCA is allowed). When the information about the transmission mode for the uplink data is set to a second value, the uplink data is transmitted based on scheduling (that is, EDCA is not allowed). Here, the information about the transmission mode for the uplink data is one bit, and thus the first value may be 0 and the second value may be 1.

The first band may be a 2.4 GHz or 5 GHz band, and the second band may be a 6 GHz band.

The beacon frame may further include information about a transmission mode for the uplink data for each channel in a third band. Here, the first band may be a 2.4 GHz band, the second band may be a 5 GHz band, and the third band may be a 6 GHz band (a triple band is configured).

The beacon frame may be transmitted in the second band. The first STA and the second STA support the 802.11ax WLAN system and the EHT WLAN system, respectively, and thus may also receive the beacon frame in the second band.

Next, an example of configuring information about a transmission mode for uplink data for each channel in each band is illustrated.

The first band may include a first channel and the second channel. The second band may include a third channel and a fourth channel. The first channel may be a primary channel of the first band, and the second channel may be a secondary channel of the first band. The third channel may be a primary channel of the second band, and the fourth channel may be a secondary channel of the second band. This channelization in which the two bands and the two channels per band are configured is merely an example, and the WLAN system may support various numbers of bands and channels.

When information about a transmission mode for the uplink data for the first channel is set to the first value, the uplink data may be transmitted in the first channel based on contention.

When information about a transmission mode for the uplink data for the second channel is set to the second value, the uplink data may be transmitted in the second channel based on scheduling.

That is, based on the information indicated by the beacon frame, EDCA may be allowed in the first channel in the first band, and EDCA may not be allowed in the second channel.

When information about a transmission mode for the uplink data for the third channel is set to the first value, the uplink data may be transmitted in the third channel based on contention.

When information about a transmission mode for the uplink data for the fourth channel is set to the second value, the uplink data may be transmitted in the fourth channel based on scheduling.

That is, based on the information indicated by the beacon frame, EDCA may be allowed in the third channel in the second band, and EDCA may not be allowed in the fourth channel.

To transmit the uplink data based on scheduling, a trigger frame is needed.

Therefore, the AP may transmit a trigger frame to the first STA and the second STA. The AP may transmit the trigger frame before receiving the uplink data after transmitting the beacon frame.

The uplink data may be transmitted through a resource unit (RU) allocated in the third channel or the fourth channel based on the trigger frame.

Further, when the trigger frame includes an identifier of the first STA and does not include an identifier of the second STA, the uplink data may received only from the first STA. According to the trigger frame, the second STA cannot transmit uplink data.

That is, the trigger frame may determine a STA to transmit uplink data through identifier information and may determine a resource unit for transmitting data in a channel allowed for scheduling-based data transmission through allocation information.

The beacon frame may further include a multi-user (MU) enhanced distributed channel access (EDCA) parameter set element. The MU EDCA parameter set element may be an element defined in the 802.11ax system.

The MU EDCA parameter set element may include a parameter record field for each access category (AC). The parameter record field may include information about a MU EDCA timer. When the information about the MU EDCA timer is set to a third value, the uplink data may be transmitted based on scheduling.

The AC may include AC_Best Effort (BE), AC_Background (BK), AC_Video (VI), and AC_Voice (VO).

The parameter record field may further include an arbitration inter-frame space number (AIFSN) field. When the AIFSN field is set to 0, EDCA for the uplink data may not be performed during a period specified by the MU EDCA timer.

FIG. 24 is a flowchart illustrating a procedure for a STA to transmit uplink data according to an embodiment.

The embodiment of FIG. 24 may be performed in a network environment supporting a next-generation WLAN system. The next-generation WLAN system may be a WLAN system evolving from an 802.11ax system and may satisfy backward compatibility with the 802.11ax system.

The embodiment of FIG. 24 may be performed by a reception device, and the reception device may correspond to a STA (non-AP STA). The STA may include a first STA and a second STA. The first STA may support an 802.11ax WLAN system and a second STA may support an extremely high throughput (EHT) WLAN system. In the embodiment of FIG. 24, a transmission device may correspond to an access point (AP).

In operation S2410, the STA receives a beacon frame from the AP.

In operation S2420, the STA transmits uplink data to the AP based on the beacon frame.

The beacon frame includes information about a transmission mode for the uplink data for each channel in a first band and each channel in a second band. When the information about the transmission mode for the uplink data is set to a first value, the uplink data is transmitted based on contention (that is, EDCA is allowed). When the information about the transmission mode for the uplink data is set to a second value, the uplink data is transmitted based on scheduling (that is, EDCA is not allowed). Here, the information about the transmission mode for the uplink data is one bit, and thus the first value may be 0 and the second value may be 1.

The first band may be a 2.4 GHz or 5 GHz band, and the second band may be a 6 GHz band.

The beacon frame may further include information about a transmission mode for the uplink data for each channel in a third band. Here, the first band may be a 2.4 GHz band, the second band may be a 5 GHz band, and the third band may be a 6 GHz band (a triple band is configured).

The beacon frame may be transmitted in the second band. The first STA and the second STA support the 802.11ax WLAN system and the EHT WLAN system, respectively, and thus may also receive the beacon frame in the second band.

Next, an example of configuring information about a transmission mode for uplink data for each channel in each band is illustrated.

The first band may include a first channel and the second channel. The second band may include a third channel and a fourth channel. The first channel may be a primary channel of the first band, and the second channel may be a secondary channel of the first band. The third channel may be a primary channel of the second band, and the fourth channel may be a secondary channel of the second band. This channelization in which the two bands and the two channels per band are configured is merely an example, and the WLAN system may support various numbers of bands and channels.

When information about a transmission mode for the uplink data for the first channel is set to the first value, the uplink data may be transmitted in the first channel based on contention.

When information about a transmission mode for the uplink data for the second channel is set to the second value, the uplink data may be transmitted in the second channel based on scheduling.

That is, based on the information indicated by the beacon frame, EDCA may be allowed in the first channel in the first band, and EDCA may not be allowed in the second channel.

When information about a transmission mode for the uplink data for the third channel is set to the first value, the uplink data may be transmitted in the third channel based on contention.

When information about a transmission mode for the uplink data for the fourth channel is set to the second value, the uplink data may be transmitted in the fourth channel based on scheduling.

That is, based on the information indicated by the beacon frame, EDCA may be allowed in the third channel in the second band, and EDCA may not be allowed in the fourth channel.

To transmit the uplink data based on scheduling, a trigger frame is needed.

Therefore, the AP may transmit a trigger frame to the first STA and the second STA. The AP may transmit the trigger frame before receiving the uplink data after transmitting the beacon frame.

The uplink data may be transmitted through a resource unit (RU) allocated in the third channel or the fourth channel based on the trigger frame.

Further, when the trigger frame includes an identifier of the first STA and does not include an identifier of the second STA, the uplink data may received only from the first STA. According to the trigger frame, the second STA cannot transmit uplink data.

That is, the trigger frame may determine a STA to transmit uplink data through identifier information and may determine a resource unit for transmitting data in a channel allowed for scheduling-based data transmission through allocation information.

The beacon frame may further include a multi-user (MU) enhanced distributed channel access (EDCA) parameter set element. The MU EDCA parameter set element may be an element defined in the 802.11ax system.

The MU EDCA parameter set element may include a parameter record field for each access category (AC). The parameter record field may include information about a MU EDCA timer. When the information about the MU EDCA timer is set to a third value, the uplink data may be transmitted based on scheduling.

The AC may include AC_Best Effort (BE), AC_Background (BK), AC_Video (VI), and AC_Voice (VO).

The parameter record field may further include an arbitration inter-frame space number (AIFSN) field. When the AIFSN field is set to 0, EDCA for the uplink data may not be performed during a period specified by the MU EDCA timer.

3. Device Configuration

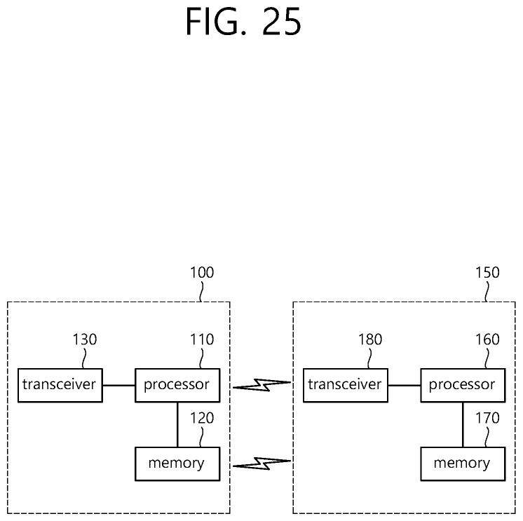

FIG. 25 is a diagram illustrating a device for implementing the aforementioned method.

A wireless device 100 of FIG. 25 is a transmission device capable of implementing the aforementioned embodiment, and may operate as an AP STA. A wireless device 150 of FIG. 25 is a reception device capable of implementing the aforementioned embodiment, and may operate as a non-AP STA.

The transmission device (100) may include a processor (110), a memory (120), and a transmitting/receiving unit (130), and the reception device (150) may include a processor (160), a memory (170), and a transmitting/receiving unit (180). The transmitting/receiving unit (130, 180) transmits/receives a radio signal and may be operated in a physical layer of IEEE 802.11/3GPP, and so on. The processor (110, 160) may be operated in the physical layer and/or MAC layer and may be operatively connected to the transmitting/receiving unit (130, 180).

The processor (110, 160) and/or the transmitting/receiving unit (130, 180) may include application-specific integrated circuit (ASIC), other chipset, logic circuit and/or data processor. The memory (120, 170) may include read-only memory (ROM), random access memory (RAM), flash memory, memory card, storage medium and/or other storage unit. When the embodiments are executed by software, the techniques (or methods) described herein can be executed with modules (e.g., processes, functions, and so on) that perform the functions described herein. The modules can be stored in the memory (120, 170) and executed by the processor (110, 160). The memory (120, 170) can be implemented (or positioned) within the processor (110, 160) or external to the processor (110, 160). Also, the memory (120, 170) may be operatively connected to the processor (110, 160) via various means known in the art.

The processor 110, 160 may implement the functions, processes and/or methods proposed in the present disclosure. For example, the processor 110, 160 may perform the operation according to the present embodiment.

A specific operation of the processor (110) of the transmission device is as follows. The processor (110) of the transmission device transmits a beacon frame to a first STA or a second STA and receives uplink data from the first STA or the second STA based on the beacon frame.

A specific operation of the processor (160) of the reception device is as follows. The processor (160) of the reception device receives a beacon frame from an AP and transmits uplink data to the AP based on the beacon frame.

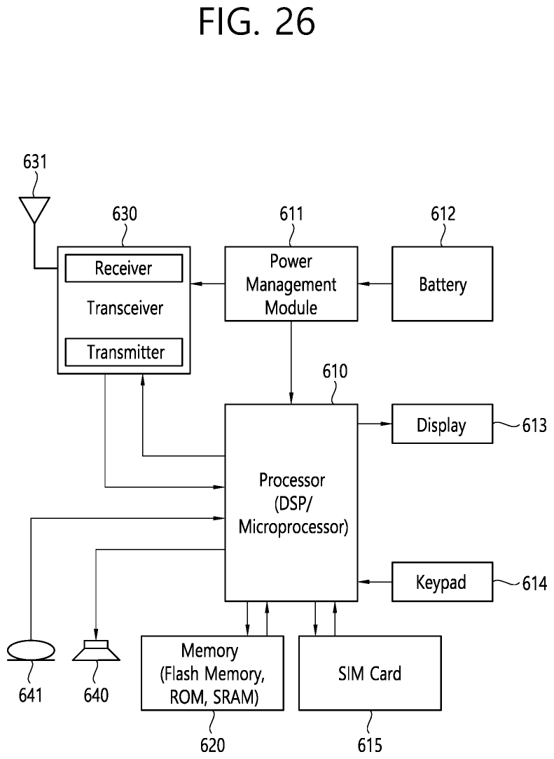

FIG. 26 shows more detailed wireless device to implement an embodiment of the present disclosure. The present disclosure described above for the transmission device or the reception device may be applied to this embodiment.

A wireless device includes a processor 610, a power management module 611, a battery 612, a display 613, a keypad 614, a subscriber identification module (SIM) card 615, a memory 620, a transceiver 630, one or more antennas 631, a speaker 640, and a microphone 641.

The processor 610 may be configured to implement proposed functions, procedures and/or methods described in this description. Layers of the radio interface protocol may be implemented in the processor 610. The processor 610 may include ASIC, other chipset, logic circuit and/or data processing device. The processor 610 may be an application processor (AP). The processor 610 may include at least one of a digital signal processor (DSP), a central processing unit (CPU), a graphics processing unit (GPU), a modem (modulator and demodulator). An example of the processor 610 may be found in SNAPDRAGON™ series of processors made by Qualcomm®, EXYNOS™ series of processors made by Samsung®, A series of processors made by Apple HELIO™ series of processors made by MediaTek®, ATOM™ series of processors made by Intel® or a corresponding next generation processor.

The power management module 611 manages power for the processor 610 and/or the transceiver 630. The battery 612 supplies power to the power management module 611. The display 613 outputs results processed by the processor 610. The keypad 614 receives inputs to be used by the processor 610. The keypad 614 may be shown on the display 613. The SIM card 615 is an integrated circuit that is intended to securely store the international mobile subscriber identity (IMSI) number and its related key, which are used to identify and authenticate subscribers on mobile telephony devices (such as mobile phones and computers). It is also possible to store contact information on many SIM cards.

The memory 620 is operatively coupled with the processor 610 and stores a variety of information to operate the processor 610. The memory 620 may include ROM, RAM, flash memory, memory card, storage medium and/or other storage device. When the embodiments are implemented in software, the techniques described herein can be implemented with modules (e.g., procedures, functions, and so on) that perform the functions described herein. The modules can be stored in the memory 620 and executed by the processor 610. The memory 620 can be implemented within the processor 610 or external to the processor 610 in which case those can be communicatively coupled to the processor 610 via various means as is known in the art.

The transceiver 630 is operatively coupled with the processor 610, and transmits and/or receives a radio signal. The transceiver 630 includes a transmitter and a receiver. The transceiver 630 may include baseband circuitry to process radio frequency signals. The transceiver 630 controls the one or more antennas 631 to transmit and/or receive a radio signal.

The speaker 640 outputs sound-related results processed by the processor 610. The microphone 641 receives sound-related inputs to be used by the processor 610.

In the transmission device, the processor (610) transmits a beacon frame to a first STA or a second STA and receives uplink data from the first STA or the second STA based on the beacon frame.

In the reception device, the processor (610) receives a beacon frame from an AP and transmits uplink data to the AP based on the beacon frame.

The beacon frame includes information about a transmission mode for the uplink data for each channel in a first band and each channel in a second band. When the information about the transmission mode for the uplink data is set to a first value, the uplink data is transmitted based on contention (that is, EDCA is allowed). When the information about the transmission mode for the uplink data is set to a second value, the uplink data is transmitted based on scheduling (that is, EDCA is not allowed). Here, the information about the transmission mode for the uplink data is one bit, and thus the first value may be 0 and the second value may be 1.

The first band may be a 2.4 GHz or 5 GHz band, and the second band may be a 6 GHz band.

The beacon frame may further include information about a transmission mode for the uplink data for each channel in a third band. Here, the first band may be a 2.4 GHz band, the second band may be a 5 GHz band, and the third band may be a 6 GHz band (a triple band is configured).

The beacon frame may be transmitted in the second band. The first STA and the second STA support the 802.11ax WLAN system and the EHT WLAN system, respectively, and thus may also receive the beacon frame in the second band.

Next, an example of configuring information about a transmission mode for uplink data for each channel in each band is illustrated.

The first band may include a first channel and the second channel. The second band may include a third channel and a fourth channel. The first channel may be a primary channel of the first band, and the second channel may be a secondary channel of the first band. The third channel may be a primary channel of the second band, and the fourth channel may be a secondary channel of the second band. This channelization in which the two bands and the two channels per band are configured is merely an example, and the WLAN system may support various numbers of bands and channels.

When information about a transmission mode for the uplink data for the first channel is set to the first value, the uplink data may be transmitted in the first channel based on contention.

When information about a transmission mode for the uplink data for the second channel is set to the second value, the uplink data may be transmitted in the second channel based on scheduling.

That is, based on the information indicated by the beacon frame, EDCA may be allowed in the first channel in the first band, and EDCA may not be allowed in the second channel.

When information about a transmission mode for the uplink data for the third channel is set to the first value, the uplink data may be transmitted in the third channel based on contention.

When information about a transmission mode for the uplink data for the fourth channel is set to the second value, the uplink data may be transmitted in the fourth channel based on scheduling.

That is, based on the information indicated by the beacon frame, EDCA may be allowed in the third channel in the second band, and EDCA may not be allowed in the fourth channel.

To transmit the uplink data based on scheduling, a trigger frame is needed.

Therefore, the AP may transmit a trigger frame to the first STA and the second STA. The AP may transmit the trigger frame before receiving the uplink data after transmitting the beacon frame.

The uplink data may be transmitted through a resource unit (RU) allocated in the third channel or the fourth channel based on the trigger frame.

Further, when the trigger frame includes an identifier of the first STA and does not include an identifier of the second STA, the uplink data may received only from the first STA. According to the trigger frame, the second STA cannot transmit uplink data.

That is, the trigger frame may determine a STA to transmit uplink data through identifier information and may determine a resource unit for transmitting data in a channel allowed for scheduling-based data transmission through allocation information.

The beacon frame may further include a multi-user (MU) enhanced distributed channel access (EDCA) parameter set element. The MU EDCA parameter set element may be an element defined in the 802.11ax system.

The MU EDCA parameter set element may include a parameter record field for each access category (AC). The parameter record field may include information about a MU EDCA timer. When the information about the MU EDCA timer is set to a third value, the uplink data may be transmitted based on scheduling.

The AC may include AC_Best Effort (BE), AC_Background (BK), AC_Video (VI), and AC_Voice (VO).

The parameter record field may further include an arbitration inter-frame space number (AIFSN) field. When the AIFSN field is set to 0, EDCA for the uplink data may not be performed during a period specified by the MU EDCA timer.

What is claimed is:

1. A method for receiving uplink data a wireless local area network (WLAN) system, the method comprising:
transmitting, by a access point (AP), a beacon frame to a first station (STA) or a second STA; and
receiving, by the AP, uplink data from the first STA or the second STA based on the beacon frame,
wherein the beacon frame comprises information about a transmission mode for the uplink data for each channel in a first band and each channel in a second band,
the uplink data is transmitted based on contention when the information about the transmission mode for the uplink data is set to a first value, and
the uplink data is transmitted based on scheduling when the information about the transmission mode for the uplink data is set to a second value.

2. The method of claim 1, wherein the first band is a 2.4 GHz or 5 GHz band,
the second band is a 6 GHz band,
the first band comprises a first channel and a second channel, and
the second band comprises a third channel and a fourth channel.

3. The method of claim 2, wherein the uplink data is transmitted in the first channel based on contention when the information about the transmission mode for the uplink data for the first channel is set to the first value,
the uplink data is transmitted in the second channel based on scheduling when the information about the transmission mode for the uplink data for the second channel is set to the second value,
the uplink data is transmitted in the third channel based on contention when the information about the transmission mode for the uplink data for the third channel is set to the first value, and
the uplink data is transmitted in the fourth channel based on scheduling when the information about the transmission mode for the uplink data for the fourth channel is set to the second value.

4. The method of claim 3, further comprising:
transmitting, by the AP, a trigger frame to the first STA and the second STA,
wherein the uplink data is transmitted through a resource unit (RU) allocated in the third channel or the fourth channel based on the trigger frame.

5. The method of claim 4, wherein when the trigger frame comprises an identifier of the first STA and does not comprise an identifier of the second STA, the uplink data is received only from the first STA.

6. The method of claim 1, wherein the beacon frame further comprises a multi-user (MU) enhanced distributed channel access (EDCA) parameter set element,
the MU EDCA parameter set element comprises a parameter record field for each access category (AC),
the parameter record field comprises information about a MU EDCA timer, and
the uplink data is transmitted based on scheduling when the information about the MU EDCA timer is set to a third value.

7. The method of claim 6, wherein the AC comprises AC_Best Effort (BE), AC_Background (BK), AC_Video (VI), and AC_Voice (VO),
the parameter record field further comprises an arbitration inter-frame space number (AIFSN) field, and
EDCA for the uplink data is not performed during a period specified by the MU EDCA timer when the AIFSN field is set to 0.

8. The method of claim 1, wherein the beacon frame is transmitted in the second band,
the first STA supports an 802.11ax WLAN system, and
the second STA supports an extremely high throughput (EHT) WLAN system.

9. An access point (AP) for receiving uplink data in a wireless local area network (WLAN) system, the AP comprising:
a memory;
a transceiver; and
a processor operatively connected with the memory and the transceiver,
wherein the processor transmits a beacon frame to a first station (STA) or a second STA and receives uplink data from the first STA or the second STA based on the beacon frame,
the beacon frame comprises information about a transmission mode for the uplink data for each channel in a first band and each channel in a second band,
the uplink data is transmitted based on contention when the information about the transmission mode for the uplink data is set to a first value, and
the uplink data is transmitted based on scheduling when the information about the transmission mode for the uplink data is set to a second value.

10. The AP of claim 9, wherein the first band is a 2.4 GHz or 5 GHz band,
the second band is a 6 GHz band,
the first band comprises a first channel and a second channel, and
the second band comprises a third channel and a fourth channel.

11. The AP of claim 10, wherein the uplink data is transmitted in the first channel based on contention when the information about the transmission mode for the uplink data for the first channel is set to the first value,
the uplink data is transmitted in the second channel based on scheduling when the information about the transmission mode for the uplink data for the second channel is set to the second value,
the uplink data is transmitted in the third channel based on contention when the information about the transmission mode for the uplink data for the third channel is set to the first value, and
the uplink data is transmitted in the fourth channel based on scheduling when the information about the transmission mode for the uplink data for the fourth channel is set to the second value.

12. The AP of claim 11, wherein the processor transmits a trigger frame to the first STA and the second STA, and
the uplink data is transmitted through a resource unit (RU) allocated in the third channel or the fourth channel based on the trigger frame.

13. The AP of claim 12, wherein when the trigger frame comprises an identifier of the first STA and does not comprise an identifier of the second STA, the uplink data is received only from the first STA.

14. The AP of claim 9, wherein the beacon frame further comprises a multi-user (MU) enhanced distributed channel access (EDCA) parameter set element,
the MU EDCA parameter set element comprises a parameter record field for each access category (AC),
the parameter record field comprises information about a MU EDCA timer, and
the uplink data is transmitted based on scheduling when the information about the MU EDCA timer is set to a third value.

15. The AP of claim 14, wherein the AC comprises AC_Best Effort (BE), AC_Background (BK), AC_Video (VI), and AC_Voice (VO),
the parameter record field further comprises an arbitration inter-frame space number (AIFSN) field, and
EDCA for the uplink data is not performed during a period specified by the MU EDCA timer when the AIFSN field is set to 0.

16. The AP of claim 9, wherein the beacon frame is transmitted in the second band,
the first STA supports an 802.11ax WLAN system, and
the second STA supports an extremely high throughput (EHT) WLAN system.

17. A method for transmitting uplink data a wireless local area network (WLAN) system, the method comprising:
receiving, by a station (STA), a beacon frame from an access point (AP); and
transmitting, by the STA, uplink data to the AP based on the beacon frame,
wherein the beacon frame comprises information about a transmission mode for the uplink data for each channel in a first band and each channel in a second band,
the uplink data is transmitted based on contention when the information about the transmission mode for the uplink data is set to a first value, and
the uplink data is transmitted based on scheduling when the information about the transmission mode for the uplink data is set to a second value.
